(19) United States
(12) Patent Application Publication
(10) Pub. No.: US 2015/0332060 A1
(43) Pub. Date: Nov. 19, 2015

(54) SYSTEM, COMMUNICATION APPARATUS, AND COMMUNICATION METHOD

(71) Applicants: Naoki Tsumura, Kanagawa (JP); Susumu Fujioka, Kanagawa (JP)

(72) Inventors: Naoki Tsumura, Kanagawa (JP); Susumu Fujioka, Kanagawa (JP)

(73) Assignee: RICOH COMPANY, LTD., Tokyo (JP)

(21) Appl. No.: 14/715,809

(22) Filed: May 19, 2015

(30) Foreign Application Priority Data
May 19, 2014 (JP) 2014-103435
Mar. 12, 2015 (JP) 2015-049287

(51) Int. Cl. G06F 21/62; H04W 12/08; H04L 29/06; H04W 4/00

(52) U.S. Cl. CPC G06F 21/62; H04W 4/008; H04W 12/08; H04L 63/1441; G06F 2221/2149

(57) ABSTRACT

A system includes a plurality of communication apparatuses, the plurality of communication apparatuses performing communication using predetermined information. Each of the plurality of communication apparatuses includes a detection unit configured to detect a first signal issued from a first signaling part and a second signal issued from a second signaling part; and a communication unit configured to perform the communication with another communication apparatus of the plurality of communication apparatuses within an area where the detection unit can detect the first signal and the second signal.

### BACKGROUND OF THE INVENTION

1. Field of the Invention

The present invention relates to a system, a communication apparatus, and a communication method.

2. Description of the Related Art

In a Personal Area Network (PAN) that wirelessly connects devices in a predetermined area such as a conference room or a conference site, a Personal Identification Number (PIN) code is used as information to permit connection (authentication information). The PAN where connection is permitted through this PIN code poses a risk of having classified information stolen since a terminal that has obtained the PIN code in an unauthorized manner can access the PAN. Further, there is a method for delivering such a PIN code to participants of the conference via email or the like, by which the participants set the delivered PIN code in a mobile terminal, for example. This method also poses a problem in that an operation to set the PIN code is complicated or troublesome for the participants.

In connection with these matters, it is a well-known technique to obtain, by a wireless LAN parent device, a network identifier and an encryption key assigned to a wireless LAN child device in advance from a server device and establish communication connection with the wireless LAN child device using the obtained information (see Patent Document 1, for example).

However, in a system disclosed in Patent Document 1, it is necessary to set the network identifier and the encryption key for the wireless LAN child device in advance (upon factory shipment, for example). Accordingly, if such information set in advance is obtained by an unauthorized third party, there is a risk of unauthorized connection with a network or unauthorized access to information on the network by the third party. Or the unauthorized third party may use a legitimate wireless LAN child device registered with the server device and connect with a conference network from a neighboring conference room, thereby accessing information about the conference, for example.

In this manner, a technique in related art has difficulty in facilitating setting of network connection while ensuring security of the network connection.

[Patent Document 1] Japanese Laid-Open Patent Application No. 2013-247533

### SUMMARY OF THE INVENTION

In view of the above-mentioned problems, it is a general object of at least one embodiment of the present invention to provide a system for facilitating setting of network connection while ensuring security of the network connection.

In an embodiment, a system including a plurality of communication apparatuses, the plurality of communication apparatuses performing communication using predetermined information, is provided. Each of the plurality of communication apparatuses includes a detection unit that detects a first signal issued from a first signaling part and a second signal issued from a second signaling part; and a communication unit that performs the communication on with another communication apparatus of the plurality of communication apparatuses within an area where the detection unit can detect the first signal and the second signal.

According to an embodiment of the present invention, it is possible to provide a system for facilitating setting of network connection while ensuring security of the network connection.

### BRIEF DESCRIPTION OF THE DRAWINGS

Other objects and further features of embodiments will become apparent from the following detailed description when read in conjunction with the accompanying drawings, in which:

FIG. 1 is a diagram showing a communication system according to an embodiment of the present invention;

FIG. 2 is a diagram showing a configuration of a communication system according to an embodiment;

FIG. 3 is a diagram showing another configuration of a communication system according to an embodiment;

FIG. 4 is a diagram showing a configuration of hardware of an ID transmitter according to an embodiment;

FIG. 5 is a diagram showing a configuration of hardware of an electronic blackboard according to an embodiment;

FIG. 6 is a diagram showing a configuration of hardware of a computer according to an embodiment;

FIG. 7 is a diagram showing a functional configuration of a communication system according to a first embodiment;

FIG. 8 is a flowchart showing a process of a communication apparatus according to a first embodiment;

FIG. 9 is a diagram showing a frame format of a management frame in a wireless LAN;

FIG. 10 is a diagram illustrating an encryption process by Wired Equivalent Privacy (WEP);

FIG. 11 is a sequence chart showing an ID obtainment process according to an embodiment;

FIG. 12 is a sequence chart (1) showing a connection process according to a first embodiment;

FIG. 13 is a sequence chart (2) showing a connection process according to a first embodiment;

FIG. 14 is a sequence chart (3) showing a connection process according to a first embodiment;

FIG. 15 is a diagram showing a functional configuration of a communication system according to a second embodiment;

FIG. 16 is a flowchart showing a process of a communication apparatus according to a second embodiment;

FIG. 17 is a sequence chart showing a MAC address obtainment process according to a second embodiment;

FIG. 18 is a sequence chart (1) showing a connection process according to a second embodiment;

FIG. 19 is a sequence chart (2) showing a connection process according to a second embodiment;

FIG. 20 is a sequence chart (3) showing a connection process according to a second embodiment;

FIG. 21 is a diagram showing another communication system according to an embodiment;

FIG. 22 is a diagram showing a functional configuration of a communication system according to a third embodiment;

FIG. 23 is a sequence chart showing an ID obtainment process according to a third embodiment;

FIG. 24 is a diagram showing a functional configuration of a communication system according to a fourth embodiment;

FIG. 25 is a diagram showing a functional configuration of a communication system according to a sixth embodiment;

FIG. 26 is a diagram showing an FHS packet according to an embodiment;

FIG. 27 is a flowchart showing a process of a first ID transmitter according to a sixth embodiment;

FIG. 28 is a flowchart showing a process of a second ID transmitter according to a sixth embodiment;

FIG. 29 is a diagram showing a configuration of a communication system according to a seventh embodiment;

FIG. 30 is a diagram showing a functional configuration of a communication system according to a seventh embodiment;

FIG. 31 is a sequence chart showing an ID obtainment process according to a seventh embodiment; and

FIG. 32 is a sequence chart showing another ID obtainment process according to a seventh embodiment.

### DESCRIPTION OF THE PREFERRED EMBODIMENTS

In the following, embodiments of the present invention will be described in detail with reference to the accompanying drawings.

### <System Configuration>

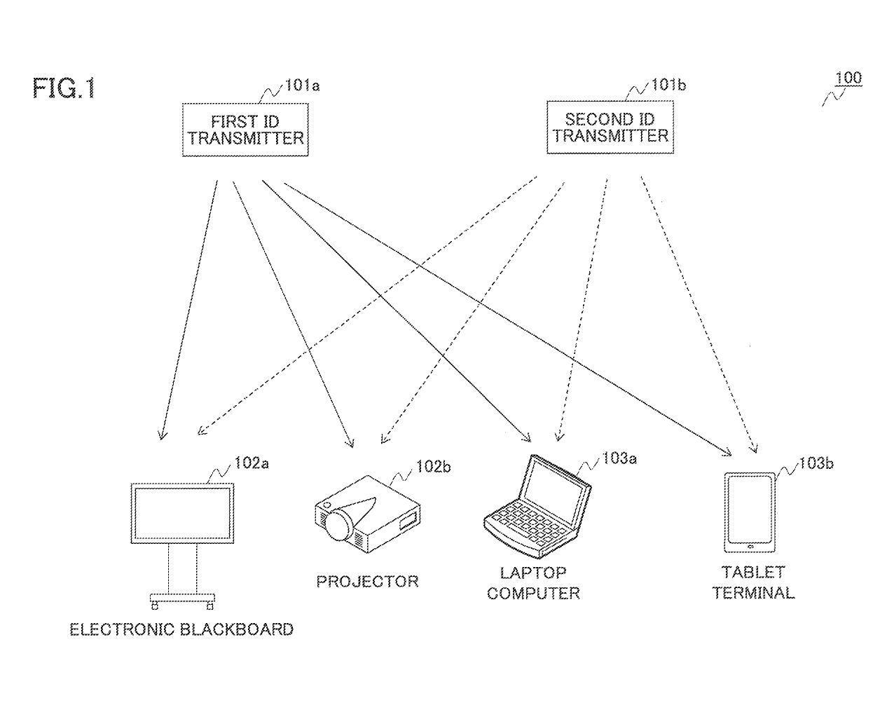

FIG. 1 is a diagram showing a communication system according to an embodiment of the present invention. A communication system 100 includes a plurality of ID transmitters (a first ID transmitter 101a, a second ID transmitter 101b), an electronic blackboard 102a, a projector 102b, a laptop computer (Personal Computer (PC)) 103a, and a tablet terminal 103b, for example. The electronic blackboard 102a and the projector 102b are examples of a plurality of electronic devices included in the communication system 100. The laptop computer 103a and the tablet terminal 103b are examples of a plurality of information terminals included in the communication system 100.

In the following descriptions, a given one of the plurality of ID transmitters is described as an “ID transmitter 101”. In the same manner, a given one of the plurality of electronic devices is described as an “electronic device 102” and a given one of the plurality of information terminals is described as an “information terminal 103”. Further, numbers of electronic devices 102 and information terminals 103 are only an example and other numbers may be employed.

The ID transmitter 101 is a device capable of performing communication by a first wireless communication method such as Bluetooth (registered trademark) and transmitting identification information by the first wireless communication method. For example, in an example shown in FIG. 1, the first ID transmitter 101a transmits first identification information by the first wireless communication method and the second ID transmitter 101b transmits second identification information by the first wireless communication method. Further, it is assumed that the first ID transmitter 101a and the second ID transmitter 101b are installed on a ceiling of a conference room, for example.

The electronic device 102 is an office device capable of performing communication by the above-mentioned first wireless communication method such as Bluetooth and communication by a second wireless communication method such as a wireless LAN. In the example shown in FIG. 1, it is assumed that the electronic blackboard 102a and the projector 102b are disposed in the conference room where the first ID transmitter 101a and the second ID transmitter 101b are installed, for example.

The information terminal 103 is an information processing device capable of performing communication by the above-mentioned first wireless communication method such as Bluetooth and communication by the above-mentioned second wireless communication method such as a wireless LAN. In the example shown in FIG. 1, it is assumed that the laptop computer 103a and the tablet terminal 103b are owned by users who participate in a conference held in the conference room where the first ID transmitter 101a and the second ID transmitter 101b are installed, for example.

The electronic device 102 and the information terminal 103 are examples of a communication apparatus according to an embodiment. The communication apparatus according to the embodiment receives (obtains) the first identification information transmitted by the first ID transmitter 101a and the second identification information transmitted by the second ID transmitter 101b. Further, based on the received first identification information and second identification information, the communication apparatus creates, using a predetermined algorithm, predetermined information (third identification information) to connect with a network. The communication apparatus further performs communication with another communication apparatus using the created predetermined information (third identification information).

In accordance with the above-mentioned configuration, in the communication system 100 according to the embodiment, the communication apparatus that can receive the first identification information and the second identification information and has the third identification information that is created based on the received first and second identification information can participate in communication of the communication system 100. In other words, connecting with the network of the communication system 100 or participating in communication thereof is impossible for a communication apparatus that cannot receive the first identification information and the second identification information or a communication apparatus that does not have an algorithm to create predetermined information (third identification information).

Further, since the communication apparatus according to the embodiment automatically receives the first identification information and the second identification information and creates the predetermined information (third identification information), the communication apparatus can connect with the network of the communication system 100 without setting a PIN code by a user, for example.

In addition, the predetermined information to connect with the network may be used by the above-mentioned first wireless communication method or the above-mentioned second wireless communication method. For example, the predetermined information may include authentication information such as a PIN code in Bluetooth communication, an encryption key in wireless LAN communication, or the like.

In accordance with the above-mentioned configuration, according to the communication system 100 of the embodiment, it is possible to facilitate setting of network connection while ensuring security of the network connection.

The configuration shown in FIG. 1 is only an example and does not limit the scope of the present invention. For example, in the configuration shown in FIG. 1, the first and second identification information is obtained by the Bluetooth communication whose communication area is relatively small and data communication is performed by the wireless LAN whose data transfer rate is high. However, if the first wireless communication method provides a sufficient data transfer rate, the first wireless communication method and the second wireless communication method may be the same. For example, a relatively fast wireless Personal Area Network (PAN) such as Ultra Wide Band (UWB) may be used to obtain the first and second identification information and perform data communication.

### <Application Example>

A specific application example of the communication system 100 is described below.

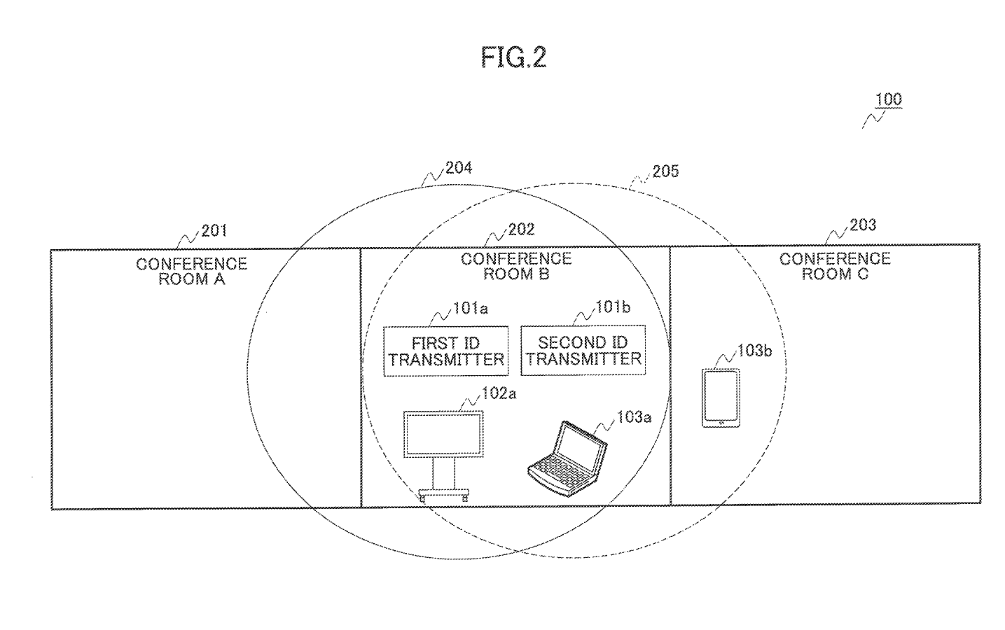

FIG. 2 is a diagram showing a configuration of a communication system according to the embodiment. In FIG. 2, it is assumed that the first ID transmitter 101a and the second ID transmitter 101b are installed on a ceiling of a conference room B 202, for example. Further, it is also assumed that a coverage area 204 of radio waves transmitted by the first ID transmitter 101a does not include an adjacent conference room C 203. In the same manner, it is assumed that a coverage area 205 of radio waves transmitted by the second ID transmitter 101b does not include an adjacent conference room A 201.

In this case, both of the electronic blackboard 102a and the laptop computer 103a in the conference room B 202 can receive the first and second identification information and create the third identification information. Accordingly, both of the electronic blackboard 102a and the laptop computer 103a can connect with the network (communication) of the communication system 100. By contrast, since the tablet terminal 103b in the conference room C 203 cannot receive the first identification information, the tablet terminal 103b cannot create the third identification information. Accordingly, the tablet terminal 103b cannot connect with the network of the communication system 100.

In this manner, in the communication system 100 according to the embodiment, it is possible to control a communication area in addition to facilitating setting of network (communication) connection.

### <Another Application Example>

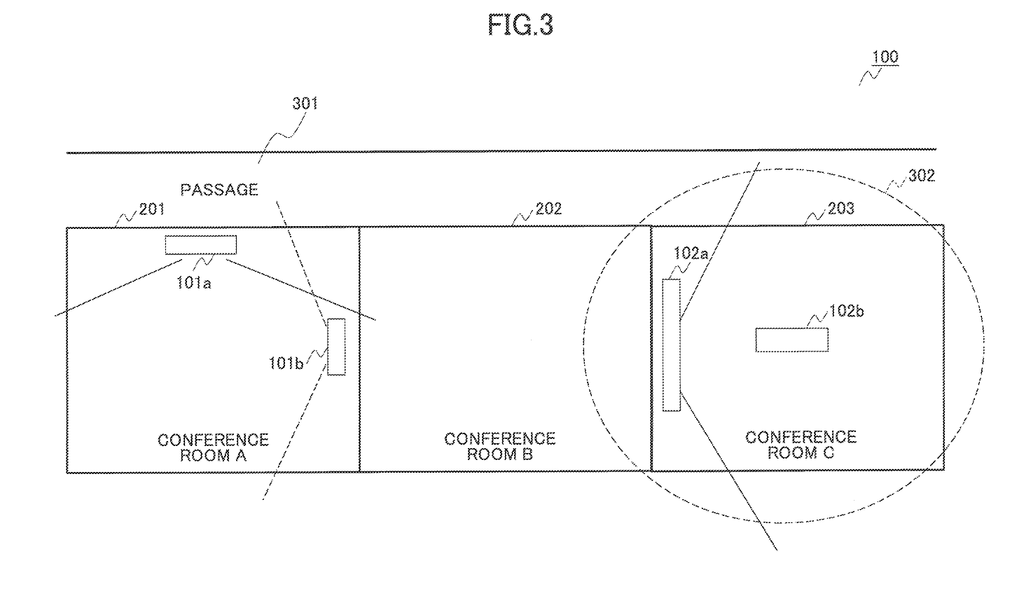

FIG. 3 is a diagram showing another configuration of a communication system according to the embodiment. While the ID transmitters 101a and 101b shown in FIG. 2 emit radio waves in all directions uniformly, the ID transmitters 101a and 101b may have directivity upon emitting radio waves.

For example, it is assumed that the first ID transmitter 101a disposed in the conference room A 201 shown in FIG. 3 emits radio waves downward in FIG. 3. Further, it is also assumed that the second ID transmitter 101b disposed in the conference room A 201 emits radio waves in a left direction in FIG. 3. In accordance with such a configuration, it is possible to effectively prevent interception of communication in a passage 301 and in the conference room B 202.

Further, the first identification information and the second identification information may be transmitted by the electronic blackboard 102a, the projector 102b, or the like disposed in the conference room C 203 in FIG. 3. For example, in a conference where the electronic blackboard 102a is used, a participant and his/her information terminal 103 are expected to be located in front of the electronic blackboard 102a (in a direction where a display surface of the electronic blackboard 102a can be viewed). Accordingly, in the example shown in FIG. 3, the electronic blackboard 102a transmits the first identification information in a right direction (where the display surface can be viewed) in FIG. 3.

By contrast, in a conference where the projector 102b is used, the participant and his/her information terminal 103 are expected to be located around the projector 102b. Accordingly, in the example shown in FIG. 3, the projector 102b transmits the second identification information in all directions in a substantially uniform manner.

When an area that allows connection with communication of the communication system 100 is formed by combining the electronic blackboard 102a with the projector 102b, it is possible to hold a plurality of conferences where interception of communication is mutually prevented even in an open space without walls, for example.

Preferably, the first identification information transmitted by the first ID transmitter 101a and/or the second identification information transmitted by the second ID transmitter 101b is changed with time (at predetermined times) or when the conference starts/ends.

For example, it is assumed that a conference is held in the conference room B 202 shown in FIG. 2 and the laptop computer 103a that created the third identification information is moved to the conference room C 203 after the conference. In accordance with this, the laptop computer 103a cannot receive the first identification information anymore. However, since the laptop computer 103a has already created the third identification information, even if another conference in which a user of the laptop computer 103a is not allowed to participate starts in the conference room B 202, it is possible to connect with the electronic blackboard 102a disposed in the conference room B 202 from the conference room C 203 and this state continues. In order to prevent such a problem, it is preferable that the first identification information to be transmitted by the first ID transmitter 101a and/or the second identification information to be transmitted by the second ID transmitter 101b will be changed based on a predetermined condition.

A number of the plurality of ID transmitters 101 may be three or more. For example, the ID transmitter 101 may be installed on each of four walls of the conference room A 201 and the third identification information necessary to connect with communication of the communication system 100 may be created on the basis of four pieces of identification information received from the four ID transmitters 101. In accordance with such a configuration, it is possible to configure the communication system 100 that prevents interception of communication in four directions of the conference room A 201, for example.

### <Hardware Configuration>

In the following, a hardware configuration of each device is described.

### (ID Transmitter)

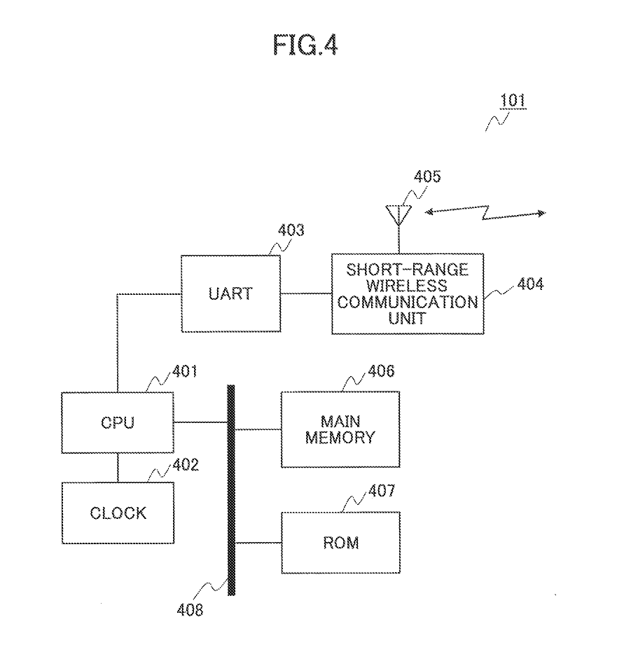

FIG. 4 is a diagram showing a configuration of hardware of an ID transmitter according to the embodiment. The ID transmitter 101 includes a Central Processing Unit (CPU) 401, a clock 402, a Universal Asynchronous Receiver Transmitter (UART) 403, a short-range wireless communication unit 404, an antenna 405, a main memory 406, a Read Only Memory (ROM) 407, a bus 408, and the like.

The CPU 401 executes and processes a control process program stored in the ROM 407. The clock 402 includes a crystal oscillator and a frequency divider circuit, for example, and creates clocks to control operation timing for the CPU 401. The UART 403 is an interface by which the CPU 401 transmits and receives serial data with the short-range wireless communication unit 404. The UART 403 includes First-In First-Out (FIFO), a shift register, and the like.

The short-range wireless communication unit 404 is a wireless module compliant with the Bluetooth standard, for example. The short-range wireless communication unit 404 includes a Radio Frequency (RF) unit and a baseband unit, for example, and transmits and receives data in Bluetooth communication via the antenna 405. In addition, Bluetooth is an example of a preferable wireless communication method (standard) and the wireless communication method may be another communication method such as ZigBee (registered trademark), UWB, Radio Frequency Identification (RFID), or the like.

The main memory 406 is configured with a Dynamic Random Access Memory (DRAM) or the like and is used as a work area of the CPU 401. The ROM 407 is configured with a flash ROM or the like and a program to control operations in the embodiment is written in the ROM 407 in advance. The bus 408 transfers address signals, data signals, various types of control signals, and the like.

### (Electronic Device)

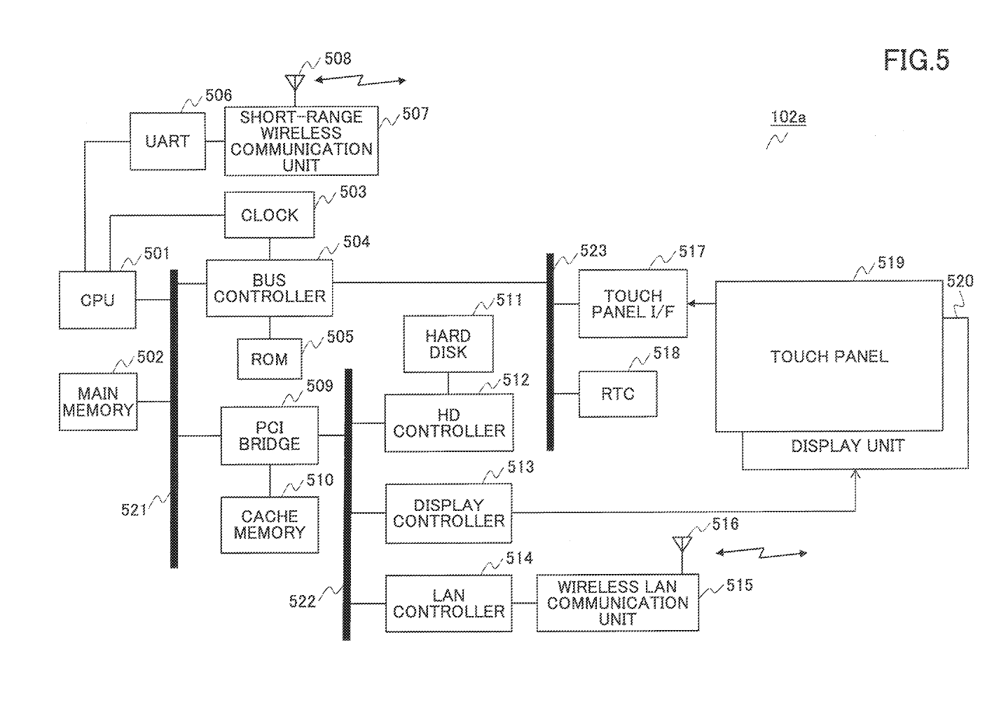

FIG. 5 is a diagram showing a configuration of hardware of the electronic blackboard 102a according to the embodiment. The configuration of hardware of the electronic blackboard 102a is described as an example of the electronic device 102. The electronic blackboard 102a is a display and input device including a display such as a Liquid Crystal Display (LCD) and an input unit such as a touch panel. The electronic blackboard 102a is capable of receiving a handwriting input such as matters to be pointed out while displaying conference material, for example. Further, the electronic blackboard 102a can record where necessary the conference material into which the pointed out matters are written.

The electronic blackboard 102a includes a CPU 501, a main memory 502, a clock 503, a bus controller 504, a ROM 505, a UART 506, a short-range wireless communication unit 507, a first antenna 508, a Peripheral Component Interconnect (PCI) bridge 509, a cache memory 510, a hard disk 511, a Hard Disk (HD) controller 512, a display controller 513, a LAN controller 514, a wireless LAN communication unit 515, a second antenna 516, a touch panel I/F 517, an RTC 518, a touch panel 519, a display unit 520, a CPU bus 521, a PCI bus 522, an X bus (internal bus) 523, and the like.

The CPU 501 executes and processes a control process program stored in the ROM 505, an Operating System (OS) read from the hard disk 511 and written to the main memory 502, various types of application programs, and the like. The main memory 502 is used as a work area of the CPU 501. The main memory 502 includes a volatile memory such as a DRAM. The clock 503 includes a crystal oscillator and a frequency divider circuit, for example, and creates clocks to control operation timing for the CPU 501 and the bus controller 504.

The bus controller 504 controls data transfer between the CPU bus 521 and the X bus 523. The ROM 505 is a non-volatile memory in which a program to start up a system when powered on or to control various types of devices is written in advance. The PCI bridge 509 uses the cache memory 510 to transfer data between the PCI bus 522 and the CPU 501. The cache memory 510 is constituted with a DRAM or the like and is used by the PCI bridge 509.

The hard disk 511 is a storage device that stores system software, various types of application programs, data saved by a user, and the like. The HD controller 512 has an Integrated Device Electronics (IDE) interface, for example, as an interface with the hard disk 511. The HD controller 512 performs high-speed data transfer for the hard disk 511.

The display controller 513 performs Digital/Analog (D/A) conversion for character data, graphic data, and the like and control to display these types of data on the display unit 520. The LAN controller 514 executes a communication protocol compliant with the IEEE802.11 standard, for example, to control data communication with another communication apparatus via the wireless LAN communication unit 515 and the second antenna 516, the communication apparatus being connected to a wireless LAN.

The touch panel I/F 517 has a port for a touch panel and is controlled by a touch panel driver (control program). The RTC 518 is a date clock and is powered by a battery (not shown).

On the touch panel 519, a plurality of Light Emitting Diodes (LED) and phototransistors are arranged at equal spaces on opposite sides. A part where the phototransistor cannot detect light, namely, a part where light is blocked, is determined to be a location that is touched.

The display unit 520 is a large-screen display including LCD or the like.

### (Information Terminal)

The information terminal 103 has a configuration of a general-purpose computer. The information terminal 103 may be an information processing device such as a PC, a tablet terminal, a smartphone, or the like.

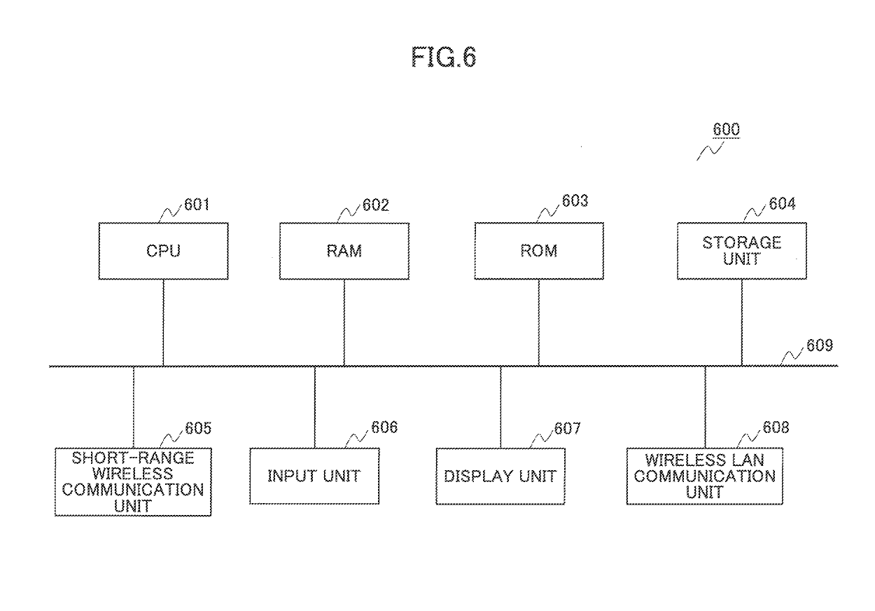

FIG. 6 is a diagram showing a configuration of hardware of a computer according to the embodiment. A computer 600 includes a CPU 601, a RAM 602, a ROM 603, a storage unit 604, a short-range wireless communication unit 605, an input unit 606, a display unit 607, a wireless LAN communication unit 608, a bus 609, and the like.

The CPU 601 is an arithmetic unit that reads a program or data stored in the ROM 603, the storage unit 604, or the like onto the RAM 602 and executes a process, thereby implementing each of functions of the computer 600. The RAM 602 is a volatile memory used as a work area of the CPU 601. The ROM 603 is a non-volatile memory that stores a program or data even in a powered-off state. The ROM 603 is constituted with a flash ROM or the like.

The storage unit 604 is a storage device such as a Hard Disk Drive (HDD), a Solid State Drive (SSD), or the like and stores an Operation System (OS), application programs, and various types of data.

The short-range wireless communication unit 605 is a wireless module compliant with the Bluetooth standard, for example. The short-range wireless communication unit 605 includes an RF unit, a baseband unit, an antenna, and the like and transmits and receives data in Bluetooth communication. In addition, Bluetooth is an example of a preferable wireless communication method (standard). The input unit 606 includes a pointing device such as a mouse and a keyboard. The input unit 606 is used to input an operation signal to the computer 600. The display unit 607 includes a display and displays a process result or the like by the computer 600.

The wireless LAN communication unit 608 includes an RF unit, an antenna, a baseband unit, a communication control unit, and the like and executes a communication protocol compliant with the IEEE802.11 standard, for example, to communicate data in wireless LAN communication. The bus 609 is connected to each of the above-mentioned constituent elements and transfers address signals, data signals, various types of control signals, and the like.

### <Functional Configuration>

### First Embodiment

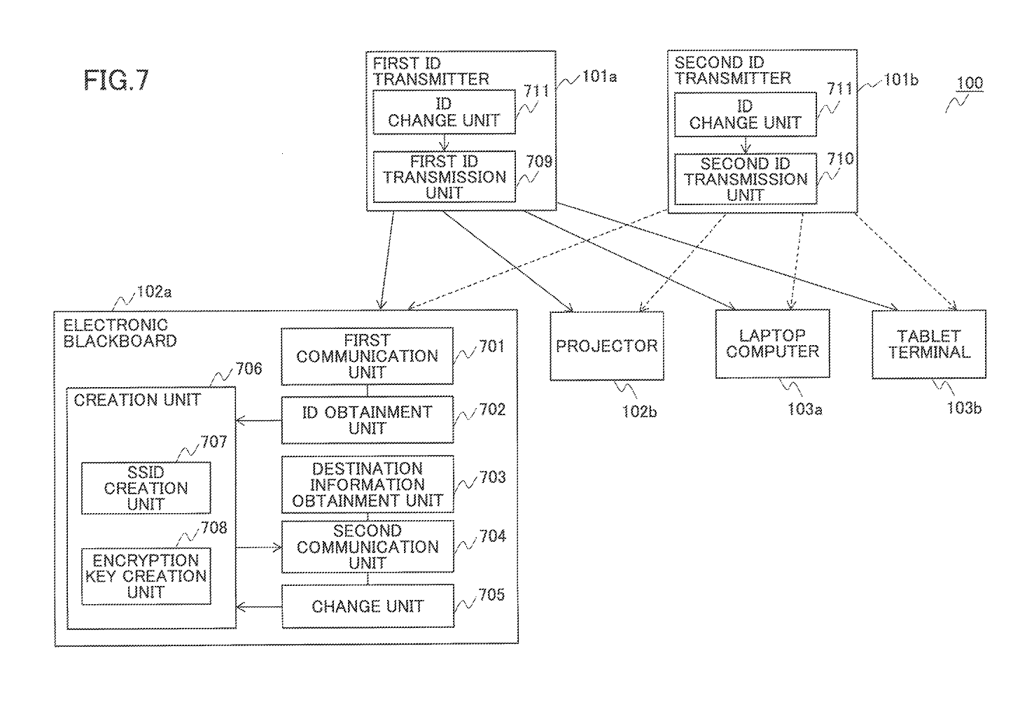

FIG. 7 is a diagram showing a functional configuration of a communication system according to a first embodiment.

### (Functional Configuration of Communication Apparatus)

The electronic blackboard 102a which is an example of the communication apparatus according to the present embodiment includes a first communication unit 701, an ID obtainment unit 702, a destination information obtainment unit 703, a second communication unit 704, a change unit 705, and a creation unit 706. It is assumed that the projector 102b, the laptop computer 103a, and the tablet terminal 103b serving as another communication apparatus also have the same configuration.

The first communication unit 701 performs communication in Bluetooth communication, for example. The first communication unit 701 is realized using the short-range wireless communication unit 507, the first antenna 508, and the like shown in FIG. 5, for example.

The ID obtainment unit (detection unit) 702 uses the first communication unit 701 or the like in order to obtain (detect) first identification information (first signal) transmitted by the first ID transmitter 101a and second identification information (second signal) transmitted by the second ID transmitter 101b. The ID obtainment unit 702 is realized using a software process in accordance with a program executed by the CPU 501 shown in FIG. 5, for example.

The destination information obtainment unit 703 uses the second communication unit 704 or the like in order to obtain destination information about another communication apparatus. The destination information obtainment unit 703 is realized using a software process in accordance with a program executed by the CPU 501 shown in FIG. 5, for example. How the destination information is obtained will be described later.

The second communication unit 704 performs communication in a wireless LAN, for example. The second communication unit 704 is realized using the LAN controller 514, the wireless LAN communication unit 515, the second antenna 516, and the like shown in FIG. 5.

The creation unit 706 uses the first identification information and the second identification information obtained by the ID obtainment unit 702 in order to create predetermined information to be used in wireless LAN communication. The creation unit 706 includes a Service Set Identifier (SSID) creation unit 707, an encryption key creation unit 708, and the like.

The SSID creation unit 707 creates an SSID which serves as an identifier in a wireless LAN network according to the communication system 100 by using a predetermined algorithm based on the first identification information and the second identification information obtained by the ID obtainment unit 702. Since each communication apparatus according to the present embodiment creates the SSID by using a common algorithm, SSIDs created by the communication apparatuses have the same information.

The encryption key creation unit 708 creates an encryption key in the wireless LAN network by using a predetermined algorithm based on the first identification information and the second identification information obtained by the ID obtainment unit 702. Since each communication apparatus according to the present embodiment creates the encryption key by using a common algorithm, encryption keys created by the communication apparatuses have the same information.

The creation unit 706, the SSID creation unit 707, and the encryption key creation unit 708 are realized using a software process in accordance with a program executed by the CPU 501 shown in FIG. 5, for example.

The change unit 705 changes the algorithm to create the SSID and/or the algorithm to create the encryption key based on the first identification information and the second identification information by the creation unit 706. The change unit 705 is realized using a software process in accordance with a program executed by the CPU 501 shown in FIG. 5, for example.

### (Functional Configuration of ID Transmitter)

The first ID transmitter 101a includes a first ID transmission unit 709 and an ID change unit 711, for example.

The first ID transmission unit 709 transmits the first identification information and is realized using the short-range wireless communication unit 404, the antenna 405, and a software process in accordance with a program executed by the CPU 401 shown in FIG. 4, for example.

The ID change unit 711 changes the first identification information transmitted by the first ID transmission unit 709. The ID change unit 711 is realized using a software process in accordance with a program executed by the CPU 401 shown in FIG. 4, for example.

The second ID transmitter 101b includes a second ID transmission unit 710 and the ID change unit 711, for example. The second ID transmission unit 710 transmits the second identification information and is realized using the short-range wireless communication unit 404, the antenna 405, and a software process in accordance with a program executed by the CPU 401 shown in FIG. 4, for example.

The ID change unit 711 changes the second identification information transmitted by the second ID transmission unit 710. The ID change unit 711 is realized using a software process in accordance with a program executed by the CPU 401 shown in FIG. 4, for example.

The first ID transmitter 101a and the second ID transmitter 101b transmit pieces of identification information that are basically different from each other. However, since the first ID transmitter 101a and the second ID transmitter 101b operate independently of each other, there may be a period when the same identification information is transmitted if identification information is changed with time, for example.

In accordance with the above-mentioned configuration, the communication apparatus according to the present embodiment (the electronic blackboard 102a, the projector 102b, the laptop computer 103a, the tablet terminal 103b, or the like) obtains the first identification information transmitted by the first ID transmitter 101a and the second identification information transmitted by the second ID transmitter 101b. Further, the communication apparatus creates predetermined information (such as the SSID and the encryption key) used for wireless LAN communication based on the first identification information and the second identification information that are obtained and the algorithm common to each communication apparatus and uses the created predetermined information to perform wireless LAN communication.

In accordance with this, the communication system 100 according to the present embodiment can facilitate setting of network connection while ensuring security of the network connection.

### <Flow of Process>

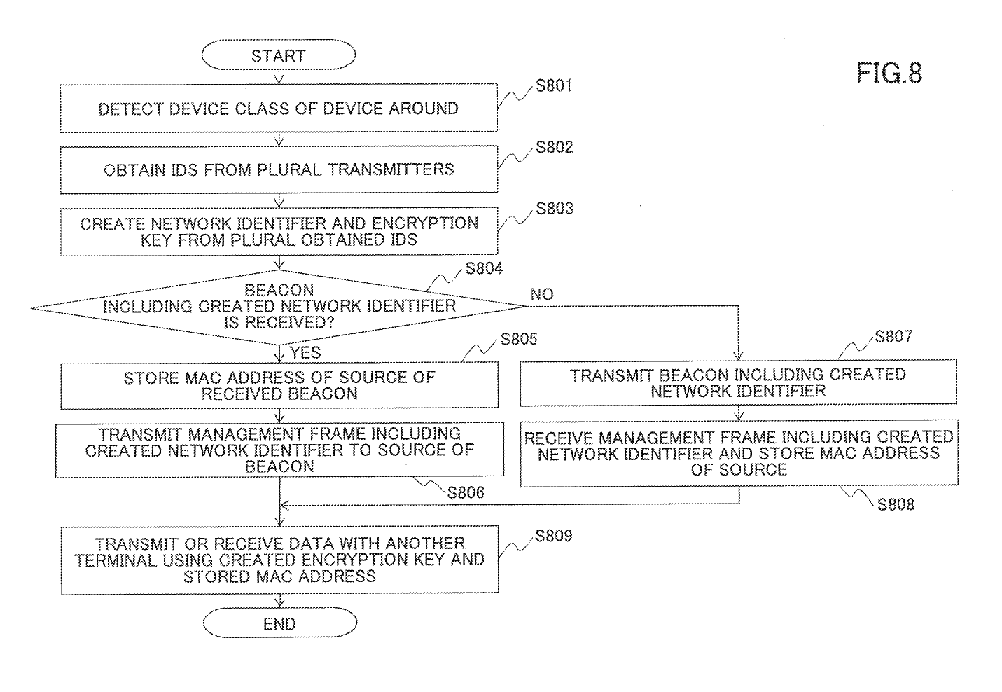

FIG. 8 is a flowchart showing a process of the communication apparatus according to the first embodiment. In the following, it is assumed that in a system configuration shown in FIG. 2, a conference is held in the conference room B 202, and the first ID transmitter 101a and the second ID transmitter 101b installed on the ceiling or the like are powered on.

In this state, when a participant of the conference having the laptop computer 103a which is powered on enters the conference room B 202, the first communication unit 701 of the laptop computer 103a detects a device class of a device present in the vicinity of the laptop computer 103a in an inquiry procedure of Bluetooth (step S801).

The device class refers to information indicative of a type of a Bluetooth device. However, since there is no standardized code for a device code indicative of the ID transmitter 101, a code originally defined from undefined codes is used, for example. In step S801, it is possible to identify the ID transmitter 101 present in the vicinity of the laptop computer 103a by detecting the device class.

In step S802, the ID obtainment unit 702 obtains first identification information (ID) and second identification information (ID) in Bluetooth communication described later from a plurality of detected ID transmitters 101, namely, from the first ID transmitter 101a and the second ID transmitter 101b.

In step S803, the creation unit 706 creates a network identifier (SSID, for example) in wireless LAN communication and an encryption key by using a predetermined algorithm based on the first ID and the second ID obtained by the ID obtainment unit 702.

An example of an arithmetic expression to create the SSID is given by Formula (1) below.

### Formula (1)

$$\frac{{\sum }_{i = 1}^{n} {X}_{i}}{n} \qquad ( 1 )$$

where n indicates a number of ID transmitters 101, Xi(i=1, 2, . . . , n) indicates an n-th ID transmitted by each ID transmitter 101, and Xi is an integer type and an arithmetic result is also an integer.

An example of an arithmetic expression to create the encryption key is given by Formula (2) below.

### Formula (2)

$$\frac{\sqrt{{\sum }_{i = 1}^{n} {( {X}_{i} + 3 )}^{2}}}{n} \qquad ( 2 )$$

where Xi is a floating-point type, an arithmetic result is a floating-point type, and a fractional part of the arithmetic result is truncated to obtain an integer.

In step S804, the destination information obtainment unit 703 uses the second communication unit 704 to determine whether a beacon frame including the SSID created by the creation unit 706 is received.

At this moment, a beacon frame including the SSID created by the creation unit 706 is not received (NO) in step S804. Accordingly, in step S807, the second communication unit 704 starts transmitting a beacon frame including the SSID created by the creation unit 706.

In step S808, when the second communication unit 704 receives a management frame, such as an association request frame, which includes the SSID created by the creation unit 706, the destination information obtainment unit 703 obtains and stores a MAC address of a source of the management frame.

In the above-mentioned description, the laptop computer 103a first transmits a beacon frame in the conference room B 202. In the following description, the electronic blackboard 102a disposed in the conference room B 202 in advance has been powered on before a participant of the conference enters the conference room B 202 and in step S804, the laptop computer 103a receives a beacon frame transmitted by the electronic blackboard 102a.

In step S804, if a beacon frame including the SSID created by the creation unit 706 is received (YES), the process proceeds to step S805.

In step S805, the destination information obtainment unit 703 stores a MAC address of a source included in the received beacon frame. In accordance with this, it is possible to obtain the MAC address of a communication apparatus that transmitted the beacon frame including the SSID created by the creation unit 706.

In step S806, the destination information obtainment unit 703 transmits a management frame, such as an association request frame, which includes the SSID created by the creation unit 706 to the communication apparatus that transmitted the beacon frame. In accordance with this, it is possible to report a MAC address of the laptop computer 103a to the communication apparatus that transmitted the beacon frame.

In the following, a frame format of a management frame in a wireless LAN is described.

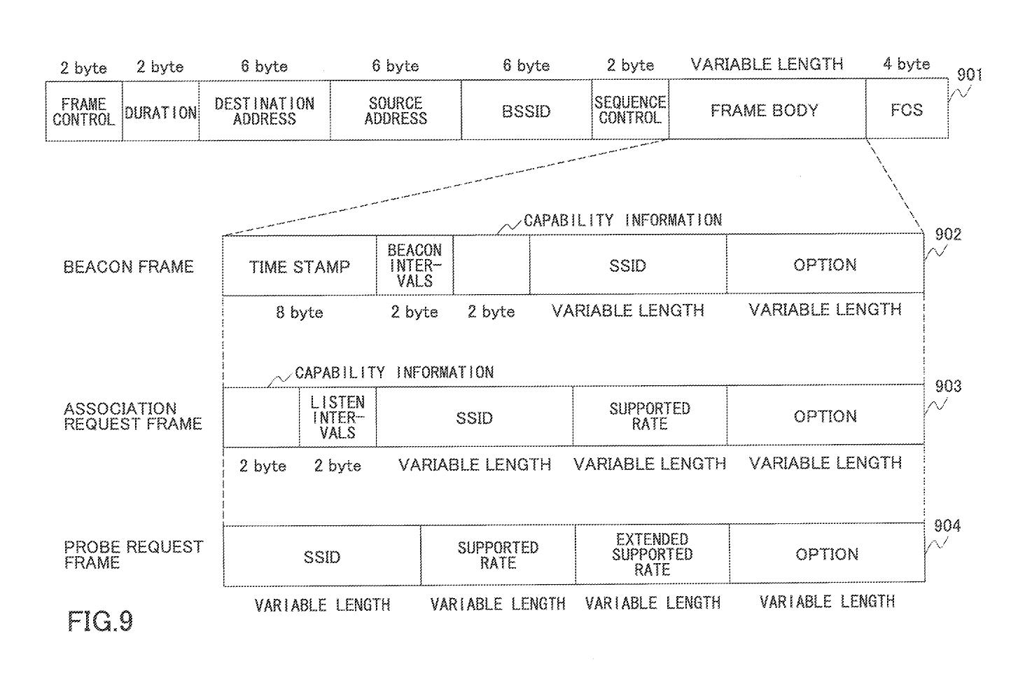

FIG. 9 is a diagram showing the frame format of the management frame in a wireless LAN. A management frame 901 includes information about frame control, duration, a destination address, a source address, a Basic Service Set Identifier (BSSID), sequence control, a frame body, a Frame Check Sequence (FCS), and the like.

The frame control includes a field such as a type or a subtype. It is possible to determine whether a MAC frame is a management frame, a control frame, or a data frame depending on a value of a type field. For example, in the type field, a (two-bit) value “00” indicates the management frame, “01” indicates the control frame, and “10” indicates the data frame.

Further, it is possible to determine a type of the management frame depending on a value of a subtype field. For example, in the subtype field, a (four-bit) value “0000” indicates an association request, “0001” indicates an association response, “0100” indicates a probe request, “0101” indicates a probe response, and “1000” indicates a beacon. Information elements included in a frame body are different depending on a type of the management frame.

A beacon frame 902 is for reporting information about a wireless LAN network and is transmitted at predetermined intervals, for example. A frame body of the beacon frame 902 includes information elements such as a time stamp, beacon intervals, capability information, and an SSID.

In accordance with the above-mentioned frame structure, a wireless LAN device such as the laptop computer 103a that has received a beacon frame can readily obtain information about a MAC address and an SSID of a source of the beacon frame.

An association request frame 903 is for requesting connection with a wireless LAN device that transmits a beacon frame, for example. A frame body of the association request frame 903 includes information elements such as capability information, listen intervals, an SSID, and a support rate. Accordingly, by setting the SSID in the association request frame 903 and transmitting it to the source of the beacon frame, it is possible to report the SSID, a MAC address, and the like of the laptop computer 103a to the source of the beacon frame.

A probe request frame 904 is used to inquire whether there is a surrounding wireless LAN device, for example. A frame body of the probe request frame 904 includes information elements such as an SSID, a support rate, and an extended support rate. Accordingly, by setting the SSID in the probe request frame 904 and transmitting it to the source of the beacon frame, it is possible to report the SSID, a MAC address, and the like of the laptop computer 103a to the source of the beacon frame.

The beacon frame, the association request frame, and the probe request frame are examples of the management frame in wireless LAN communication.

With reference to FIG. 8 again, the process of the communication apparatus according to the first embodiment is described further.

In step S809, encrypted data communication is performed with another communication apparatus by using the MAC address obtained and stored by the destination information obtainment unit 703 and the encryption key created by the creation unit 706.

The encryption key used here can be created by only those communication apparatuses that correctly receive the first ID and the second ID and have a common algorithm to create the encryption key using the first ID and the second ID.

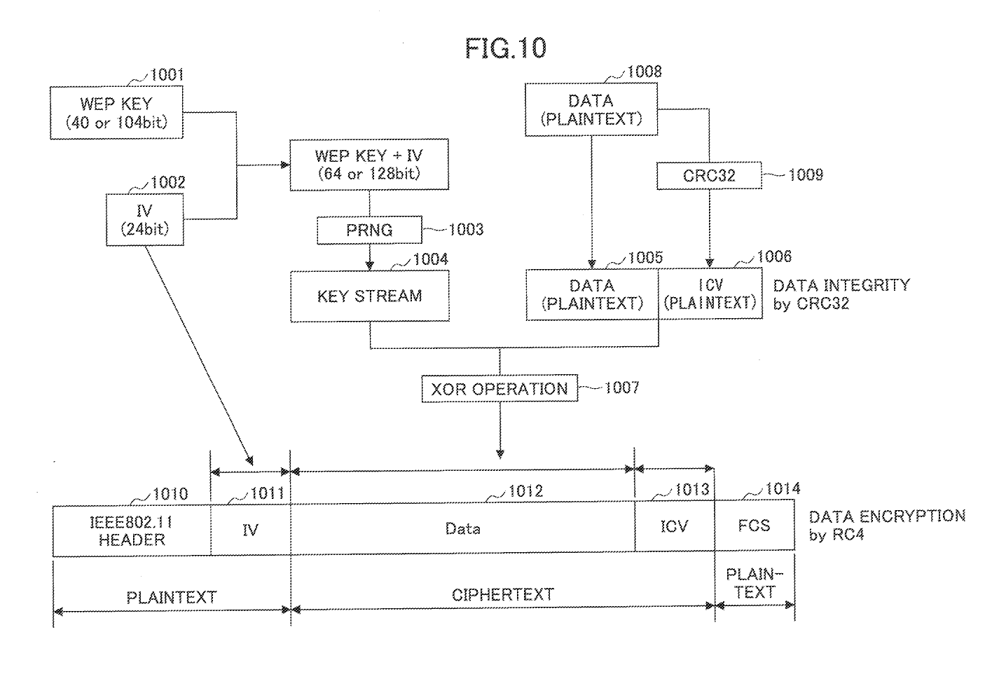

FIG. 10 is a diagram illustrating an encryption process by Wired Equivalent Privacy (WEP). The encryption process by WEP is an example of the encryption process using the encryption key according to the present embodiment.

In FIG. 10, a WEP (encryption key) 1001, and an Initialization Vector (IV) 1002 are input to a Pseudo Random Number Generator (PRNG) 1003 to create a key stream 1004. The created key stream 1004, Data (plaintext) 1005 before encryption, and an Integrity Check Value (ICV) 1006 are subjected to exclusive OR (XOR) operation 1007, thereby creating encrypted data. Further, a hash value (ICV) obtained by inputting data (plaintext) 1008 before encryption to a Cyclic Redundancy Check (CRC32) 1009 is inserted between Data 1012 and an FCS 1014. The data part (Data) 1012 and the ICV 1013 are converted to ciphertext by Rivest's Cipher (RC4) and a 24-bit IV for creating a common key used upon encryption is inserted between an IEEE802.11 header and the Data 1012. Data encryption is performed in this manner, for example.

Next, a flow of the process is described in detail with reference to a sequence chart.

### (ID Obtainment Process)

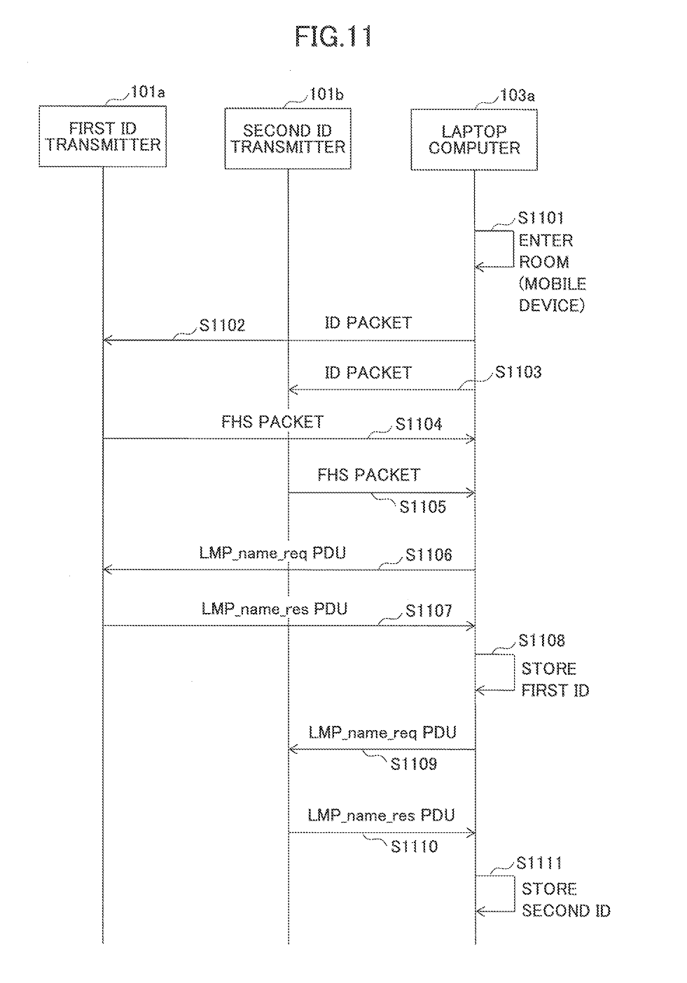

FIG. 11 is a sequence chart showing the ID obtainment process according to the embodiment. In the following description, the communication apparatus is assumed to be the laptop computer 103a.

For example, if a participant of a conference having the laptop computer 103a which is powered on enters the conference room B 202 (step S1101) shown in FIG. 2, the laptop computer 103a starts an inquiry procedure as a primary terminal of Bluetooth. If the laptop computer 103a has not established a link of Bluetooth to another terminal, the laptop computer 103a performs the inquiry procedure of Bluetooth at regular intervals (every three seconds, for example).

The laptop computer 103a repeatedly transmits an ID packet in the inquiry procedure (steps S1102 and S1103).

When the first ID transmitter 101a and the second ID transmitter 101b receive the ID packet, the first ID transmitter 101a and the second ID transmitter 101b transmit an FHS packet including information about its own Bluetooth device address, a device class of the ID transmitter 101, and the like (steps S1104 and S1105). Since the device class of the ID transmitter 101 has not been standardized as mentioned above, an originally defined code is used. The laptop computer 103a successively establishes a physical link, a connection of baseband layers for transmitting and receiving packets, and a connection between link managers with the first ID transmitter 101a and the second ID transmitter 101b.

When the connection is established between the link managers with the first ID transmitter 101a, the laptop computer 103a transmits “LMP_name_req PDU” to the first ID transmitter 101a (step S1106). When the first ID transmitter 101a receives the “LMP_name_req PDU”, the first ID transmitter 101a sets a random number (a first ID) created at regular intervals as an ASCII character string in a name fragment parameter of “LMP_name_res PDU” and transmits it to the laptop computer 103a (step S1107). Up to 248 characters (ASCII characters) can be set in the name fragment parameter.

When the laptop computer 103a receives the “LMP_name_res PDU”, the laptop computer 103a converts the ASCII character string set in the name fragment parameter into a numerical value and stores it as the first ID in the RAM 602 shown in FIG. 6, for example (step S1108). Further, the laptop computer 103a disconnects communication with the first ID transmitter 101a.

Next, when the connection is established between the link managers with the second ID transmitter 101b, the laptop computer 103a transmits “LMP_name_req PDU” to the second ID transmitter 101b (step S1109). When the second ID transmitter 101b receives the “LMP_name_req PDU”, the second ID transmitter 101b sets a random number (a second ID) created at regular intervals as an ASCII character string in a name fragment parameter of “LMP_name_res PDU” and transmits it to the laptop computer 103a (step S1110). When the laptop computer 103a receives the “LMP_name_res PDU”, the laptop computer 103a converts the ASCII character string set in the name fragment parameter into a numerical value and stores it as the second ID in the RAM 602 shown in FIG. 6, for example (step S1111). Further, the laptop computer 103a disconnects communication with the second ID transmitter 101b.

Each communication apparatus according to the present invention can obtain the first ID from the first ID transmitter 101a and the second ID from the second ID transmitter 101b in the above-mentioned procedure, for example.

If the ID transmitter 101 frequently creates the random number (the first ID and the second ID) at regular intervals, namely, if a period after which a value of the ID is switched is short, it is necessary obtain the first ID and the second ID quite often. By contrast, if the ID transmitter 101 less frequently creates the random number, namely, if the period after which a value of the ID is switched is long, security may not be sufficient. Accordingly, it is preferable that a time interval to create the first ID and the second ID is set to be an appropriate value such as every hour, every half a day, or every day depending on time and a purpose of a conference.

Further, the random number (the first ID and the second ID) created at regular intervals may not be created regularly. For example, in a system where the electronic blackboard 102a is powered on when a conference starts and the electronic blackboard 102a is powered off when the conference ends, the first ID and the second ID may be created in response to a power-on operation on the electronic blackboard 102a. In accordance with this, the first ID and the second ID are created differently for each conference and there is no need to obtain the first ID and the second ID anew during the conference.

Or the first ID and the second ID may be changed in response to a user operation on the information terminal 103, a switch-on/off operation on the ID transmitter 101, the projector 102b, an air conditioner, a light, or the like.

Further, the first ID and the second ID may not be necessarily changed by a random number. For example, a plurality of IDs may be used at random or in a predetermined order.

### (Connection Process)

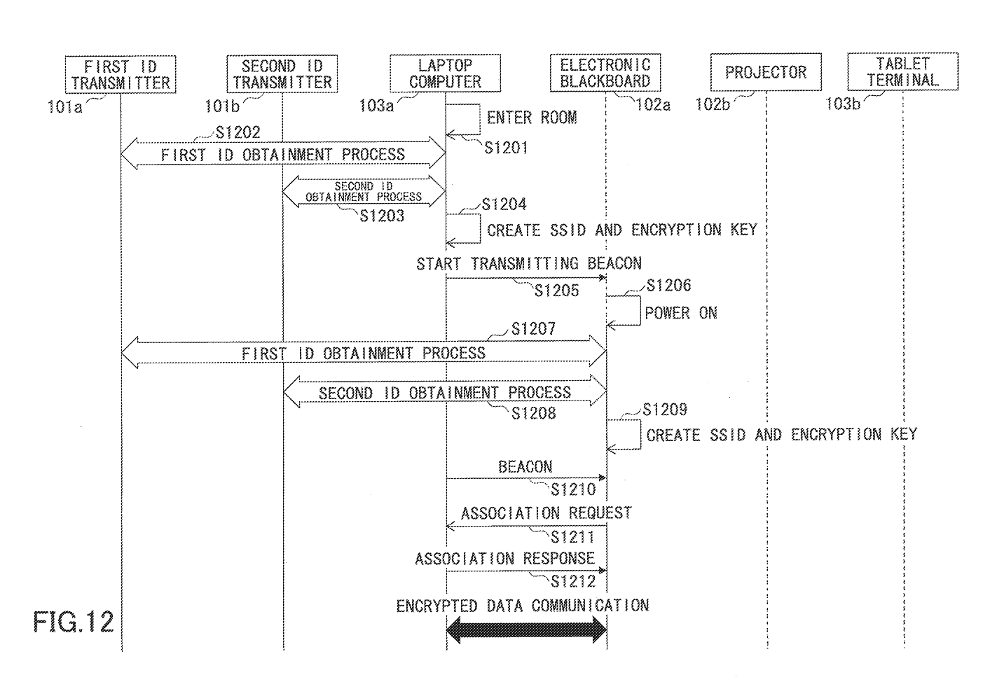

FIGS. 12-14 are sequence charts showing a connection process according to the first embodiment. It is assumed that before the process shown in FIG. 12 starts, the first ID transmitter 101a and the second ID transmitter 101b are powered on and the electronic blackboard 102a and the projector 102b are not powered on. It is also assumed that the laptop computer 103a and the tablet terminal 103b which are powered on are being brought into the conference room B 202 from another place.

In step S1201, the laptop computer 103a is brought into the conference room B 202 by a participant of the conference, for example.

In step S1202, the ID obtainment unit 702 of the laptop computer 103a obtains the first ID from the first ID transmitter 101a in a first ID obtainment process. The first ID obtainment process corresponds to steps S1102, S1104, S1106, and S1107 in FIG. 11, for example.

In step S1203, the ID obtainment unit 702 of the laptop computer 103a obtains the second ID from the second ID transmitter 101b in a second ID obtainment process. The second ID obtainment process corresponds to steps S1103, S1105, S1109, and S1110 in FIG. 11, for example.

In step S1204, the creation unit 706 of the laptop computer 103a creates the SSID in wireless LAN communication and the encryption key based on the first ID and the second ID obtained by the ID obtainment unit 702.

In step S1205, since a beacon frame is not transmitted by the electronic blackboard 102a or the projector 102b, the second communication unit 704 starts transmitting a beacon frame including the SSID created in step S1204. At this moment, the tablet terminal 103b has not been brought into the conference room B 202. Thereafter, the laptop computer 103a continuously transmits the beacon frame at predetermined intervals (100 ms, for example).

In step S1206, the electronic blackboard 102a is powered on by a user operation, for example.

In step S1207, the ID obtainment unit 702 of the electronic blackboard 102a obtains the first ID from the first ID transmitter 101a in the first ID obtainment process.

In step S1208, the ID obtainment unit 702 of the electronic blackboard 102a obtains the second ID from the second ID transmitter 101b in the second ID obtainment process.

In step S1209, the creation unit 706 of the electronic blackboard 102a creates the SSID in wireless LAN communication and the encryption key based on the first ID and the second ID obtained by the ID obtainment unit 702.

In step S1210, the second communication unit 704 of the electronic blackboard 102a receives the beacon frame transmitted by the laptop computer 103a at predetermined intervals. The beacon frame received from the laptop computer 103a includes the same SSID as the SSID created by the creation unit 706 of the electronic blackboard 102a. The destination information obtainment unit 703 of the electronic blackboard 102a obtains and stores the MAC address of the source included in the received beacon frame.

In step S1211, the destination information obtainment unit 703 of the electronic blackboard 102a transmits a management frame, such as an association request frame, which includes the SSID created by the creation unit 706 to the laptop computer 103a that transmitted the beacon frame.

In step S1212, the laptop computer 103a receives the association request frame and transmits an association response frame to the electronic blackboard 102a.

In accordance with the above-mentioned process, destination information (MAC addresses) about both devices is recognized between the laptop computer 103a and the electronic blackboard 102a and data communication using data frames encrypted by a common encryption key is possible.

Step S1211 where the electronic blackboard 102a transmits the association request frame is an example. Another management frame including the SSID may be used or the SSID may be included in a payload portion of a data frame.

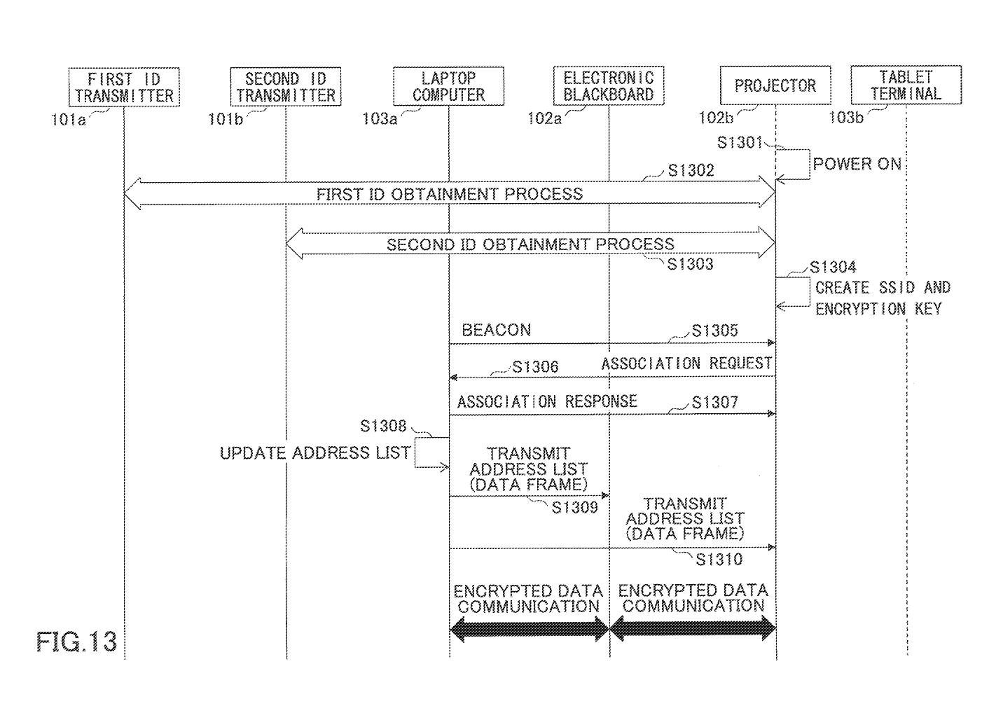

Next, a process that follows step S1212 shown in FIG. 12 is described with reference to FIG. 13.

In step S1301, the projector 102b is powered on by a user operation, for example.

In step S1302, the ID obtainment unit 702 of the projector 102b obtains the first ID from the first ID transmitter 101a in the first ID obtainment process.

In step S1303, the ID obtainment unit 702 of the projector 102b obtains the second ID from the second ID transmitter 101b in the second ID obtainment process.

In step S1304, the creation unit 706 of the projector 102b creates the SSID in wireless LAN communication and the encryption key based on the first ID and the second ID obtained by the ID obtainment unit 702.

In step S1305, the second communication unit 704 of the projector 102b receives the beacon frame transmitted by the laptop computer 103a at predetermined intervals. The beacon frame received from the laptop computer 103a includes the same SSID as the SSID created by the creation unit 706 of the projector 102b. The destination information obtainment unit 703 of the projector 102b obtains and stores the MAC address of the source included in the received beacon frame.

In step S1306, the destination information obtainment unit 703 of the projector 102b transmits a management frame, such as an association request frame, which includes the SSID created by the creation unit 706 to the laptop computer 103a which is the source of the beacon frame.

In step S1307, the laptop computer 103a receives the association request frame and transmits an association response frame to the projector 102b.

In step S1308, the destination information obtainment unit 703 of the laptop computer 103a updates an address list by storing a MAC address of the projector 102b that requested connection in response to the beacon frame transmitted by the laptop computer 103a. The address list includes a plurality of MAC addresses of communication apparatuses to which the laptop computer 103a transmitted the association response frame, for example.

In step S1309, the destination information obtainment unit 703 of the laptop computer 103a transmits the updated address list to the electronic blackboard 102a by using a data frame, for example.

In step S1310, the destination information obtainment unit 703 of the laptop computer 103a transmits the updated address list to the projector 102b by using a data frame, for example.

In accordance with the above-mentioned process, MAC addresses of devices are recognized among the laptop computer 103a, the electronic blackboard 102a, and the projector 102b and data communication using data frames encrypted by a common encryption key is possible.

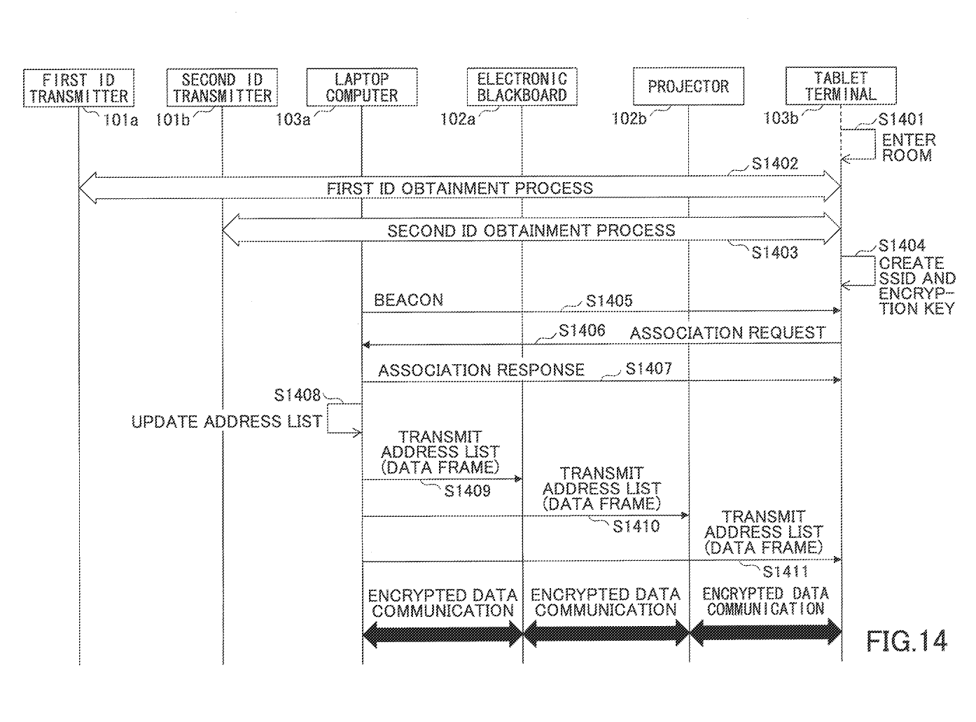

Next, a process that follows step S1310 shown in FIG. 13 is described with reference to FIG. 14.

In step S1401, the tablet terminal 103b which is powered on is brought into the conference room B 202 by a participant who is late for the conference, for example.

In step S1402, the ID obtainment unit 702 of the tablet terminal 103b obtains the first ID from the first ID transmitter 101a in the first ID obtainment process.

In step S1403, the ID obtainment unit 702 of the tablet terminal 103b obtains the second ID from the second ID transmitter 101b in the second ID obtainment process.

In step S1404, the creation unit 706 of the tablet terminal 103b creates the SSID in wireless LAN communication and the encryption key based on the first ID and the second ID obtained by the ID obtainment unit 702.

In step S1405, the second communication unit 704 of the tablet terminal 103b receives the beacon frame transmitted by the laptop computer 103a at predetermined intervals. The beacon frame received from the laptop computer 103a includes the same SSID as the SSID created by the creation unit 706 of the tablet terminal 103b. The destination information obtainment unit 703 of the tablet terminal 103b obtains and stores the MAC address of the source included in the received beacon frame.

In step S1406, the destination information obtainment unit 703 of the tablet terminal 103b transmits a management frame, such as an association request frame, which includes the SSID created by the creation unit 706 to the laptop computer 103a which is the source of the beacon frame.

In step S1407, the laptop computer 103a receives the association request frame and transmits an association response frame to the tablet terminal 103b.

In step S1408, the destination information obtainment unit 703 of the laptop computer 103a updates the address list by storing a MAC address of the tablet terminal 103b that requested connection in response to the beacon frame transmitted by the laptop computer 103a. The address list includes a plurality of MAC addresses of communication apparatuses to which the laptop computer 103a transmitted the association response frame, for example.

In step S1409, the destination information obtainment unit 703 of the laptop computer 103a transmits the updated address list to the electronic blackboard 102a by using a data frame, for example.

In step S1410, the destination information obtainment unit 703 of the laptop computer 103a transmits the updated address list to the projector 102b by using a data frame, for example.

In step S1411, the destination information obtainment unit 703 of the laptop computer 103a transmits the updated address list to the tablet terminal 103b by using a data frame, for example.

In accordance with the above-mentioned process, MAC addresses of devices are recognized among the laptop computer 103a, the electronic blackboard 102a, the projector 102b, and the tablet terminal 103b and data communication using data frames encrypted by a common encryption key is possible.

As mentioned above, the communication system (100) according to the present embodiment includes the first ID transmission unit (709) that transmits the first ID and the second ID transmission unit (710) that transmits the second ID. Further, the communication system (100) includes a plurality of communication apparatuses (102a, 102b, 103a, and 103b) that perform communication (wireless LAN communication) using predetermined information (encryption key and/or SSID).

Each communication apparatus includes the ID obtainment unit (702) that obtains the first ID and the second ID and a first creation unit (706) that creates the predetermined information (encryption key and/or SSID) based at least on the first ID and the second ID that are obtained.

In accordance with this, the communication apparatus capable of receiving the first ID and the second ID and creating the encryption key using a predetermined algorithm based on the first ID and the second ID that are obtained is enabled to automatically connect with encrypted data communication of the communication system 100.

According to the present embodiment, it is possible to provide the communication system 100 for facilitating setting of network connection while ensuring security of the network connection.

Further, even if a third party obtains IDs transmitted from a plurality of ID transmitters 101, it is impossible to connect with the communication system 100 without knowing an algorithm to create the predetermined information from the obtained IDs. Accordingly, it is possible to prevent the third party from stealing classified information.

In addition, reference numerals in parentheses and names are only an example and are added in order to make understanding easier. This is not intended to limit a scope of the present invention.

### Second Embodiment

The first embodiment is described based on the example where the management frame of wireless LAN is used to obtain destination information (MAC address) about another communication apparatus. By contrast, this embodiment is described based on an example where destination information about another communication apparatus is obtained by using Bluetooth communication.

### <Functional Configuration>

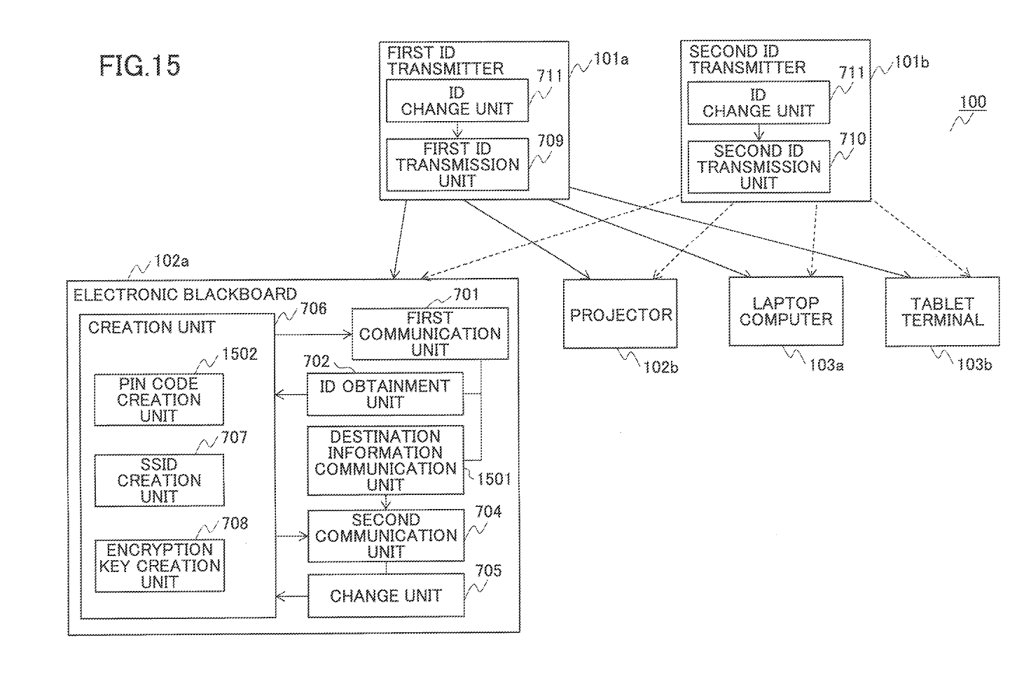

FIG. 15 is a diagram showing a functional configuration of a communication system according to a second embodiment. In an example shown in FIG. 15, the electronic blackboard 102a includes a destination information communication unit 1501 instead of the destination information obtainment unit 703 in the first embodiment shown in FIG. 7. Further, the creation unit 706 of the electronic blackboard 102a includes a PIN code creation unit 1502. In the following, a difference from the first embodiment is mainly described as other configuration is the same as in the first embodiment.

The destination information communication unit 1501 uses the first communication unit 701 in order to obtain destination information about another communication apparatus, for example. The destination information communication unit 1501 is realized using a software process in accordance with a program executed by the CPU 501 shown in FIG. 5, for example. How the destination information is obtained will be described later.

The PIN code creation unit 1502 creates a PIN code (authentication information) used in Bluetooth communication based on the first ID and the second ID obtained by the ID obtainment unit 702.

An example of an arithmetic expression to create the PIN code is given by Formula (3) below.

### Formula (3)

$$\frac{{\sum }_{i = 1}^{n} ( ( {X}_{i} \times 2 ) - ( {X}_{i} + 5 ) )}{n} \qquad ( 3 )$$

where n indicates a number of ID transmitters 101, Xi(i=1, 2, . . . , n) indicates an n-th ID transmitted by each ID transmitter 101, and Xi is an integer type and an arithmetic result is also an integer. If the arithmetic result has a negative value, the minus sign is removed to have a positive value.

The PIN code creation unit 1502 is realized using a software process in accordance with a program executed by the CPU 501 shown in FIG. 5, for example.

### <Flow of Process>

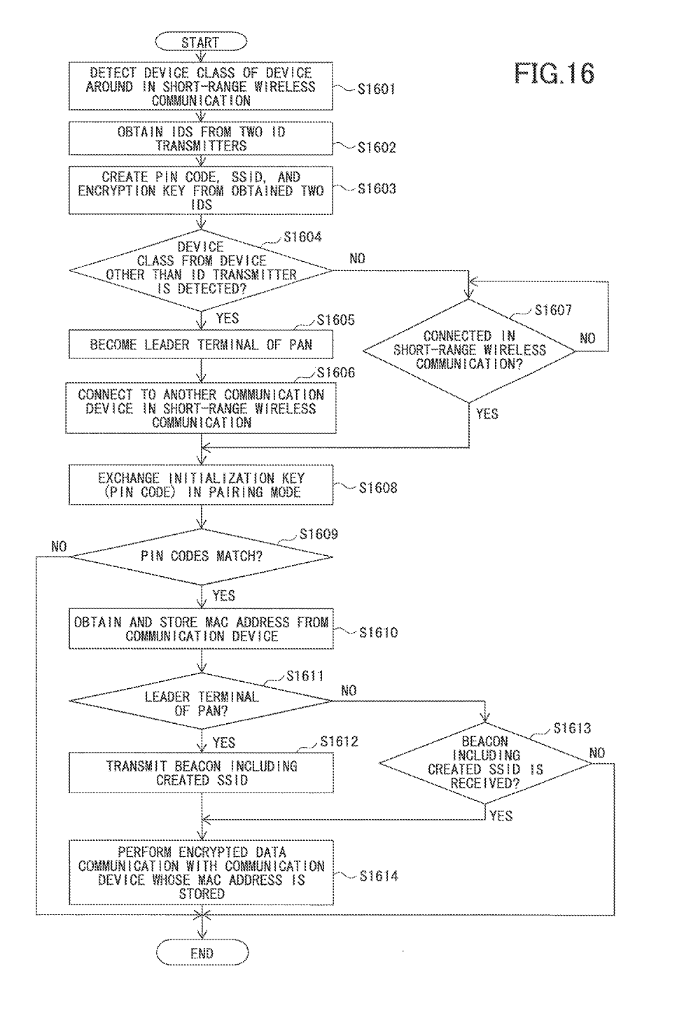

FIG. 16 is a flowchart showing a process of a communication apparatus according to the second embodiment. In the following description, it is assumed that in the system configuration shown in FIG. 2, a conference is held in the conference room B 202 and the first ID transmitter 101a and the second ID transmitter 101b installed on the ceiling, for example, have been powered on.

In this state, when a participant of the conference having the laptop computer 103a which is powered on enters the conference room B 202, the first communication unit 701 of the laptop computer 103a detects a device class of a device present in the vicinity of the laptop computer 103a in an inquiry procedure of Bluetooth (step S1601).

In step S1602, the ID obtainment unit 702 obtains the first ID and the second ID in the above-mentioned Bluetooth communication from a plurality of detected ID transmitters 101, namely, from the first ID transmitter 101a and the second ID transmitter 101b.

In step S1603, the PIN code creation unit 1502 creates a PIN code in Bluetooth communication using a predetermined algorithm such as Formula (3) based on the first ID and the second ID that are obtained by the ID obtainment unit 702. Further, the SSID creation unit 707 and the encryption key creation unit 708 create the SSID in wireless LAN communication and the encryption key, respectively, using a predetermined algorithm based on the first ID and the second ID obtained by the ID obtainment unit 702.

In step S1604, the destination information communication unit 1501 determines whether a device class from a device other than the ID transmitter 101 is detected. If the device class from the device other than the ID transmitter 101 is detected (YES) in step S1604, the process proceeds to step S1605. If the device class from the device other than the ID transmitter 101 is not detected (NO), the process proceeds to step S1607.

At this moment, since the device class from the device other than the ID transmitter 101 is not detected, the process proceeds to step S1607 and waits for being connected to another communication apparatus in Bluetooth communication.

The above-mentioned operation is performed without requiring the participant of the conference to operate the laptop computer 103a.

After the participant of the conference enters the conference room B 202, if the electronic blackboard 102a is powered on, the electronic blackboard 102a performs the operation in step S1601 to detect a device class of the laptop computer 103a, the device class indicating a computer, in addition to the device class of the ID transmitter 101.

Then, the electronic blackboard 102a performs the same operations as in step S1602 and step S1603 above in order to create the PIN code in Bluetooth communication, the SSID in wireless LAN communication, and the encryption key based on the first ID and the second ID obtained by the ID obtainment unit 702.

The destination information communication unit 1501 of the electronic blackboard 102a determines in step S1604 whether a device class from a device other than the ID transmitter 101 is detected. Since the device class from the device other than the ID transmitter 101 is detected in step S1601, the process proceeds to step S1605.

In step S1605, the destination information communication unit 1501 controls the first communication unit 701 to be a leader terminal of a Personal Area Network (PAN).

In step S1606, the destination information communication unit 1501 uses the first communication unit 701 to establish a connection between link managers with another communication apparatus by executing a communication procedure compliant with the Bluetooth standard, for example,

In step S1608, the destination information communication unit 1501 and the first communication unit 701 create an initialization key based on the PIN code created by the PIN code creation unit 1502, a Bluetooth device address, and a random number. Further, the initialization key is exchanged with another communication apparatus connected in Bluetooth in a pairing mode.

In step S1609, the destination information communication unit 1501 extracts a PIN code from an initialization key obtained from another communication apparatus and determines whether the PIN code stored in its own apparatus matches the extracted PIN code. If the PIN codes do not match (NO) in step S1609, the process ends. If the PIN codes match (YES) in step S1609, the process proceeds to step S1610.

In step S1610, the destination information communication unit 1501 establishes an OBject Exchange (OBEX) session in Bluetooth with another communication apparatus as a destination of communication and obtains and stores a MAC address of the communication apparatus. In this case, the destination information communication unit 1501 transmits a MAC address of its own apparatus to the communication apparatus in response to a request from the communication apparatus and then disconnects the Bluetooth communication.

In step S1611, the electronic blackboard 102a determines whether it is the leader terminal of a wireless LAN network (PAN). In the present embodiment, it is assumed that a terminal that is connected in Bluetooth by detecting a device class of a communication apparatus other than the device class indicating the ID transmitter 101 functions as the leader terminal of the wireless LAN network (PAN) thereafter. The electronic blackboard 102a becomes the leader terminal of the wireless LAN network (YES) in step S1611 and its process proceeds to step S1612. By contrast, since the laptop computer 103a is not the leader terminal of the wireless LAN network (NO) in step S1611, its process proceeds to step S1613.

In step S1612, the second communication unit 704 transmits a beacon including the SSID created by the SSID creation unit 707.

In step S1613, whether the beacon including the SSID created by the SSID creation unit 707 is received is determined. If the beacon including the SSID created by the SSID creation unit 707 is not received (NO) in step S1613, the process ends. By contrast, if the beacon including the SSID created by the SSID creation unit 707 is received (YES) in step S1613, the process proceeds to step S1614.

In step S1614, it is possible to perform encrypted data communication with another communication apparatus whose MAC address is stored using the encryption key created by the encryption key creation unit 708.

Next, a flow of the process is described in detail with reference to a sequence chart.

### (MAC Address Obtainment Process)

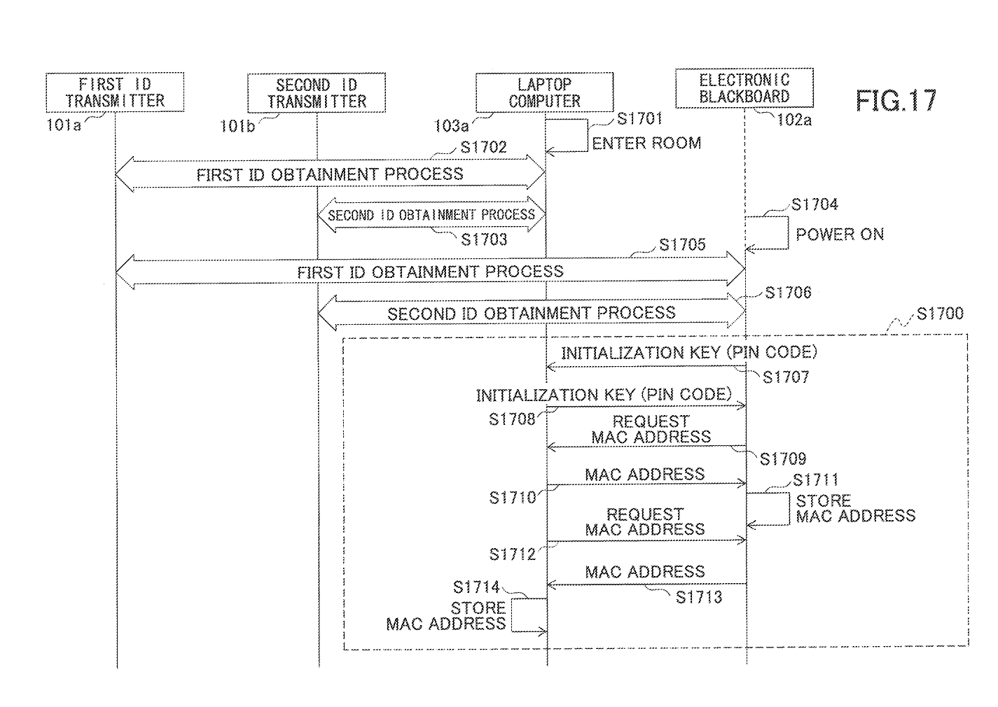

FIG. 17 is a sequence chart showing a MAC address obtainment process according to the second embodiment. FIG. 17 describes a procedure for exchanging a MAC address between the laptop computer 103a and the electronic blackboard 102a.

In step S1701, the laptop computer 103a which is powered on is brought into the conference room B 202.

In step S1702, the laptop computer 103a obtains the first ID from the first ID transmitter 101a in the first ID obtainment process. The first ID obtainment process corresponds to steps S1102, S1104, S1106, and S1107 in FIG. 11, for example.

In step S1703, the laptop computer 103a obtains the second ID from the second ID transmitter 101b in the second ID obtainment process. The second ID obtainment process corresponds to steps S1103, S1105, S1109, and S1110 in FIG. 11, for example.

The laptop computer 103a creates the PIN code in Bluetooth communication, the SSID in wireless LAN communication, the encryption key, and the like based on the first ID and the second ID that are obtained.

In step S1704, the electronic blackboard 102a is powered on.

In step S1705, the electronic blackboard 102a obtains the first ID from the first ID transmitter 101a in the first ID obtainment process.

In step S1706, the electronic blackboard 102a obtains the second ID from the second ID transmitter 101b in the second ID obtainment process.

The electronic blackboard 102a creates the PIN code in Bluetooth communication, the SSID in wireless LAN communication, the encryption key, and the like based on the first ID and the second ID that are obtained.

Then, a MAC address obtainment process S1700 is performed between the laptop computer 103a and the electronic blackboard 102a.

In step S1707, the electronic blackboard 102a creates the initialization key based on the created PIN code, the Bluetooth device address, and a random number and transmits the created initialization key to the laptop computer 103a.

In step S1708, the laptop computer 103a creates the initialization key based on the created PIN code, the Bluetooth device address, and a random number and transmits the created initialization key to the electronic blackboard 102a.

The laptop computer 103a and the electronic blackboard 102a extract a PIN code from the received initialization key and compare the extracted PIN code with its own PIN code. If the PIN codes match, the process proceeds to the next step. If the PIN codes do not match, the process ends.

In step S1709, the electronic blackboard 102a transmits a request (information) to receive a MAC address (destination information) of the laptop computer 103a to the laptop computer 103a.

In step S1710, the laptop computer 103a transmits its own MAC address to the electronic blackboard 102a in response to the request for the MAC address.

In step S1711, the electronic blackboard 102a stores the received MAC address of the information terminal 103.

In step S1712, the laptop computer 103a transmits a request (information) to receive a MAC address (destination information) of the electronic blackboard 102a to the electronic blackboard 102a.

In step S1713, the electronic blackboard 102a transmits its own MAC address to the laptop computer 103a in response to the request for the MAC address.

In step S1714, the laptop computer 103a stores the received MAC address of the electronic blackboard 102a.

According to the above-mentioned MAC address obtainment process S1700, for example, the communication apparatus of the communication system 100 can obtain destination information (MAC address) about another communication apparatus via Bluetooth communication.

### (Connection Process)

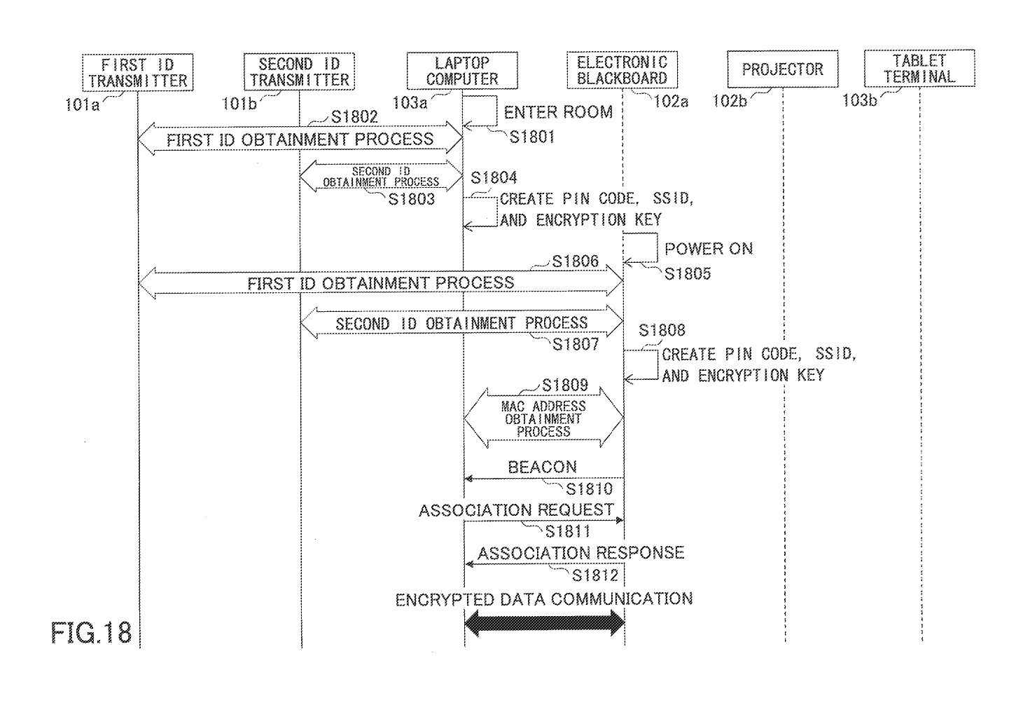

FIGS. 18-20 are sequence charts showing a connection process according to the second embodiment. It is assumed that before the process shown in FIG. 18 starts, the first ID transmitter 101a and the second ID transmitter 101b have been powered on and the electronic blackboard 102a and the projector 102b have not been powered on. It is also assumed that the laptop computer 103a and the tablet terminal 103b which are powered on are being brought into the conference room B 202 from other places.

In step S1801, the laptop computer 103a which is powered on is brought into the conference room B 202, for example.

In step S1802, the ID obtainment unit 702 of the laptop computer 103a obtains the first ID from the first ID transmitter 101a in the first ID obtainment process.

In step S1803, the ID obtainment unit 702 of the laptop computer 103a obtains the second ID from the second ID transmitter 101b in the second ID obtainment process.

In step S1804, the creation unit 706 of the laptop computer 103a creates the PIN code in Bluetooth communication, the SSID in wireless LAN communication, and the encryption key based on the first ID and the second ID obtained by the ID obtainment unit 702.

In step S1805, the electronic blackboard 102a is powered on by a user operation, for example.

In step S1806, the ID obtainment unit 702 of the electronic blackboard 102a obtains the first ID from the first ID transmitter 101a in the first ID obtainment process.

In step S1807, the ID obtainment unit 702 of the electronic blackboard 102a obtains the second ID from the second ID transmitter 101b in the second ID obtainment process.

In step S1808, the creation unit 706 of the electronic blackboard 102a creates the PIN code in Bluetooth communication, the SSID in wireless LAN communication, and the encryption key based on the first ID and the second ID obtained by the ID obtainment unit 702.

In step S1809, the laptop computer 103a and the electronic blackboard 102a obtain and store each other's MAC address in the MAC address obtainment process S1700 shown in FIG. 17.

In step S1810, the electronic blackboard 102a, for example, starts transmitting a beacon frame including the SSID created by the creation unit 706 as a leader terminal of the wireless LAN network. A communication apparatus that serves as the leader terminal of the wireless LAN network is determined in a procedure including steps S1604 and S1605 shown in FIG. 16, for example. The procedure shown in FIG. 16 is only an example and the leader terminal may be determined by another method.

In step S1811, the laptop computer 103a receives the beacon frame transmitted by the electronic blackboard 102a and transmits a management frame, such as an association request frame, which includes the SSID created by the creation unit 706 to the electronic blackboard 102a which is the source of the beacon frame.

In step S1812, the electronic blackboard 102a receives the association request frame and transmits an association response frame to the laptop computer 103a.

In accordance with the above-mentioned procedure, the laptop computer 103a and the electronic blackboard 102a have a common SSID, a common encryption key, and each other's destination information (MAC address), so that data communication encrypted by WEP, for example, is possible.

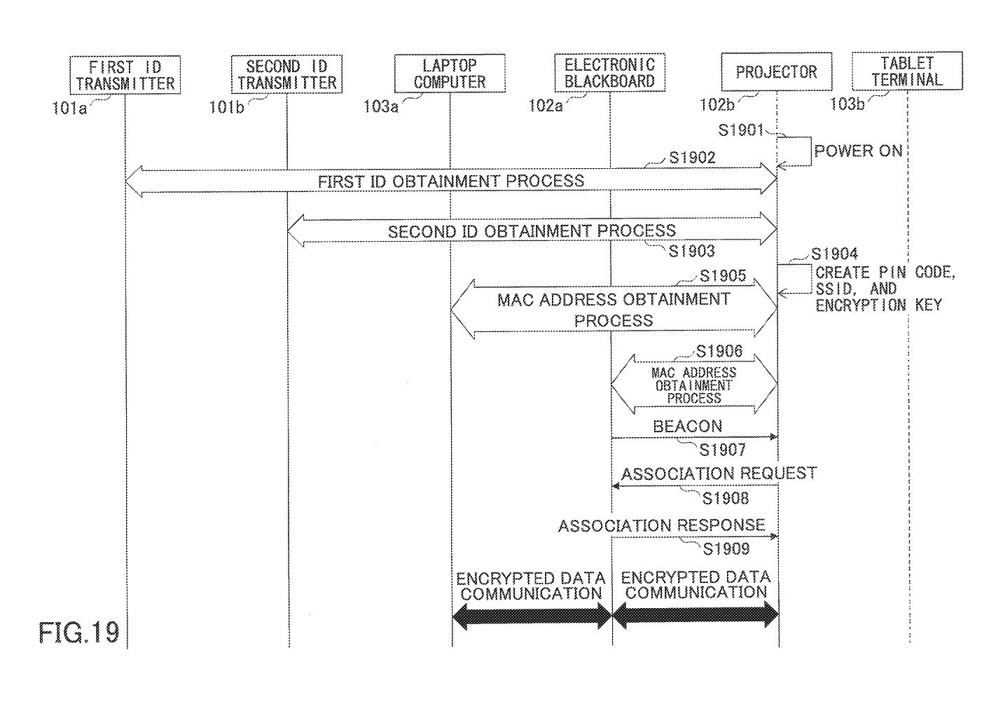

Next, a process that follows step S1812 shown in FIG. 18 is described with reference to FIG. 19.

In step S1901, the electronic blackboard 102a is powered on by a user operation, for example.

In step S1902, the ID obtainment unit 702 of the projector 102b obtains the first ID from the first ID transmitter 101a in the first ID obtainment process.

In step S1903, the ID obtainment unit 702 of the projector 102b obtains the second ID from the second ID transmitter 101b in the second ID obtainment process.

In step S1904, the creation unit 706 of the projector 102b creates the PIN code in Bluetooth communication, the SSID in wireless LAN communication, and the encryption key based on the first ID and the second ID obtained by the ID obtainment unit 702.

In step S1905, the laptop computer 103a and the projector 102b obtain and store each other's MAC address in the MAC address obtainment process S1700 shown in FIG. 17.

In step S1906, the electronic blackboard 102a and the projector 102b obtain and store each other's MAC address in the MAC address obtainment process S1700 shown in FIG. 17.

In step S1907, the projector 102b recognizes that that the electronic blackboard 102a is the leader terminal of the wireless LAN network by receiving a beacon frame transmitted by the electronic blackboard 102a, for example.

In step S1908, the projector 102b transmits a management frame, such as an association request frame, which includes the SSID created by the creation unit 706 to the electronic blackboard 102a which is the source of the beacon frame.

In step S1909, the electronic blackboard 102a receives the association request frame and transmits an association response frame to the projector 102b.

In accordance with the above-mentioned procedure, the laptop computer 103a, the electronic blackboard 102a, and the projector 102b have the common SSID, the common encryption key, and one another's destination information (MAC address), so that encrypted data communication is possible.

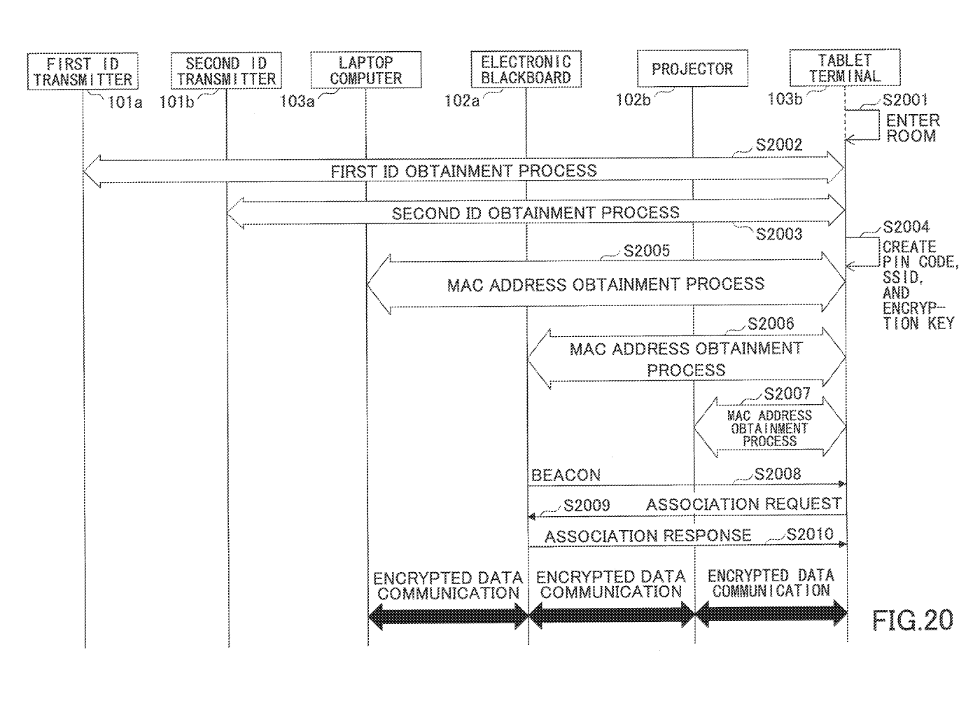

Next, a process that follows step S1909 shown in FIG. 19 is described with reference to FIG. 20.

In step S2001, the tablet terminal 103b which is powered on is brought into the conference room B 202, for example.

In step S2002, the ID obtainment unit 702 of the tablet terminal 103b obtains the first ID from the first ID transmitter 101a in the first ID obtainment process.

In step S2003, the ID obtainment unit 702 of the tablet terminal 103b obtains the second ID from the second ID transmitter 101b in the second ID obtainment process.

In step S2004, the creation unit 706 of the tablet terminal 103b creates the PIN code in Bluetooth communication, the SSID in wireless LAN communication, and the encryption key based on the first ID and the second ID obtained by the ID obtainment unit 702.

In step S2005, the laptop computer 103a and the tablet terminal 103b obtain and store each other's MAC address in the MAC address obtainment process S1700 shown in FIG. 17.

In step S2006, the electronic blackboard 102a and the tablet terminal 103b obtain and store each other's MAC address in the MAC address obtainment process S1700 shown in FIG. 17.

In step S2007, the projector 102b and the tablet terminal 103b obtain and store each other's MAC address in the MAC address obtainment process S1700 shown in FIG. 17.

In step S2008, the tablet terminal 103b recognizes that that the electronic blackboard 102a is the leader terminal of the wireless LAN network by receiving a beacon frame transmitted by the electronic blackboard 102a, for example.

In step S2009, the tablet terminal 103b transmits a management frame, such as an association request frame, which includes the SSID created by the creation unit 706 to the electronic blackboard 102a which is the source of the beacon frame.

In step S2010, the electronic blackboard 102a receives the association request frame and transmits an association response frame to the tablet terminal 103b.

In accordance with the above-mentioned procedure, the laptop computer 103a, the electronic blackboard 102a, the projector 102b, and the tablet terminal 103b have the common SSID, the common encryption key, and one another's destination information (MAC address), so that encrypted data communication is possible.

As mentioned above, the communication system (100) according to the present embodiment includes the first ID transmission unit (709) that transmits the first ID and the second ID transmission unit (710) that transmits the second ID. Further, the communication system (100) includes a plurality of communication apparatuses (102a, 102b, 103a, and 103b) that perform communication (Bluetooth communication) using predetermined information (PIN code).

Each communication apparatus includes the ID obtainment unit (702) that obtains the first ID and the second ID and a first creation unit (706) that creates the predetermined information (PIN code) based at least on the first ID and the second ID that are obtained.

In accordance with this, the communication apparatuses capable of receiving the first ID and the second ID and creating the PIN code using a predetermined algorithm based on the first ID and the second ID that are obtained are enabled to exchange destination information or the like by using Bluetooth communication. Further, it is possible to improve security by using short-range wireless communication such as Bluetooth for communication because a coverage area (a distance of communication) of radio waves is limited.

According to the present embodiment, it is possible to provide the communication system 100 for facilitating setting of network connection while ensuring security of the network connection.

Further, even if a third party obtains IDs transmitted from a plurality of ID transmitters 101, it is impossible to connect with the communication system 100 without knowing an algorithm to create the predetermined information from the obtained IDs. Accordingly, it is possible to prevent the third party from stealing classified information.

In addition, reference numerals in parentheses and names are only an example and are added in order to make understanding easier. This is not intended to limit a scope of the present invention.

### Third Embodiment

The first ID transmission unit 709 that transmits the first ID or the second ID transmission unit 710 that transmits the second ID may be included in the electronic device 102 such as the electronic blackboard 102a or the projector 102b.

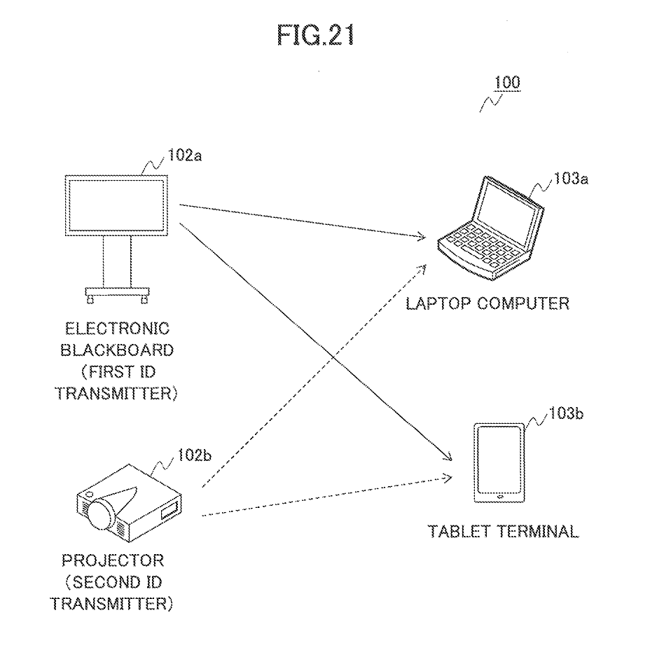

In accordance with this, as shown in FIG. 21, it is possible to install the communication system 100 according to the present invention in any location by disposing the electronic blackboard 102a or the projector 102b, for example. Further, in the present embodiment, the first ID or the second ID is transmitted by using the first communication unit 701 included in the electronic device 102, so that it is possible to reduce hardware members of the ID transmitter 101.

### <Functional Configuration>

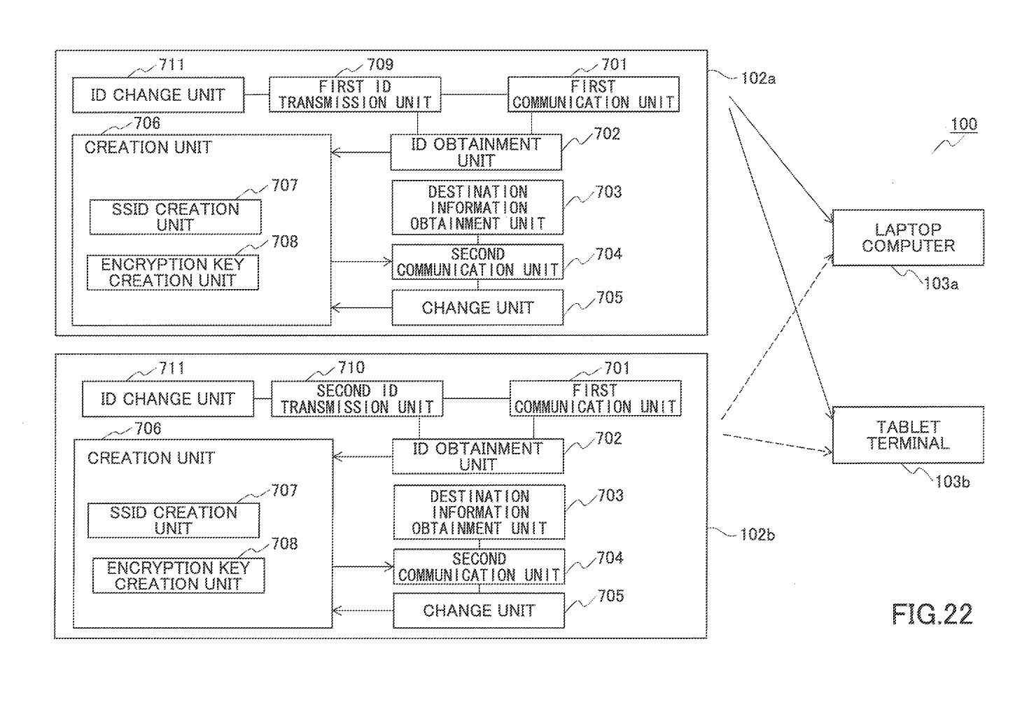

FIG. 22 is a diagram showing a functional configuration of a communication system according to a third embodiment. In an example shown in FIG. 22, the electronic blackboard 102a further includes the first ID transmission unit 709 that transmits the first ID and the ID change unit 711 in comparison with the configuration of the first embodiment shown in FIG. 7. Further, the projector 102b further includes the second ID transmission unit 710 that transmits the second ID and the ID change unit 711.

In the following, a difference from the first embodiment is mainly described, as otherwise the configuration is the same as in the first embodiment.

The first ID transmission unit 709 according to the present embodiment uses the first communication unit 701 of the electronic blackboard 102a in order to transmit the first ID in Bluetooth communication, for example. Further, the first ID transmission unit 709 is realized using a software process in accordance with a program executed by the CPU 501 shown in FIG. 5, for example.

The ID change unit 711 of the electronic blackboard 102a has the same functions as in the first embodiment. The ID change unit 711 is realized using a software process in accordance with a program executed by the CPU 501 shown in FIG. 5, for example. Accordingly, for the electronic blackboard 102a according to the present embodiment, it is not necessary to add hardware or the like to the electronic blackboard 102a in the first embodiment.

The second ID transmission unit 710 according to the present embodiment uses the first communication unit 701 of the projector 102b in order to transmit the second ID in Bluetooth communication, for example. Further, the second ID transmission unit 710 is realized using a software process in accordance with a program executed by a CPU of the projector 102b, for example.

The ID change unit 711 of the projector 102b has the same functions as in the first embodiment. The ID change unit 711 is realized using a software process in accordance with a program executed by the CPU of the projector 102b, for example. Accordingly, for the projector 102b according to the present embodiment, it is not necessary to add hardware or the like to the projector 102b in the first embodiment.

### <Flow of Process>

In the present embodiment, a procedure for obtaining the first ID and the second ID by a communication apparatus that does not include the ID transmitter 101, namely, the laptop computer 103a or the tablet terminal 103b is the same as the ID obtainment process shown in FIG. 11.

By contrast, a communication apparatus that has functions of the ID transmitter 101, namely, the electronic blackboard 102a or the projector 102b has at least one of the first ID and the second ID. Accordingly, an ID obtainment process is slightly different. In the following, the ID obtainment process between the electronic blackboard 102a that transmits the first ID and the projector 102b that transmits the second ID is described to show a difference from the first embodiment.

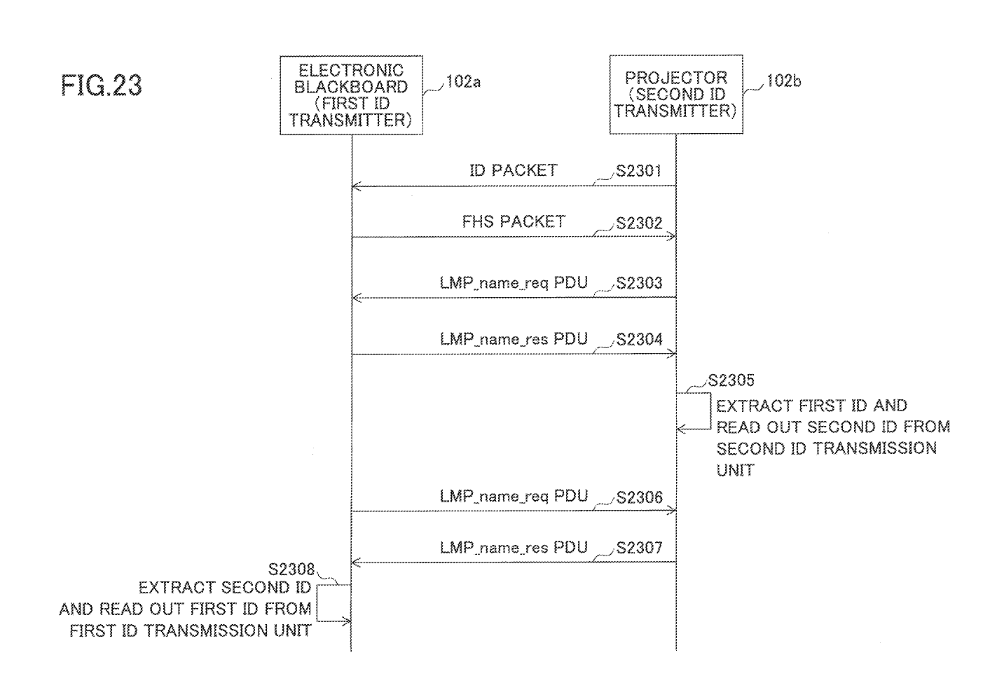

FIG. 23 is a sequence chart showing the ID obtainment process according to the third embodiment.

In step S2301, in response to a power-on operation on the projector 102b, for example, the projector 102b starts an inquiry procedure as a primary terminal of Bluetooth. In accordance with this, the projector 102b transmits an ID packet in the inquiry procedure.

In step S2302, when the electronic blackboard 102a receives the ID packet, the electronic blackboard 102a transmits an FHS packet including information about its own Bluetooth device address, a device class of the ID transmitter 101, and the like to the projector 102b.

In accordance with this, establishment of a physical link in Bluetooth communication, establishment of connection of baseband layers for transmitting and receiving packets, and establishment of a connection between link managers are successively performed between the projector 102b and the electronic blackboard 102a.

In step S2303, the projector 102b transmits “LMP_name_req PDU” to the electronic blackboard 102a.

In step S2304, when the electronic blackboard 102a receives the “LMP_name_req PDU”, the electronic blackboard 102a sets a random number (the first ID) created at regular intervals as an ASCII character string in a name fragment parameter of “LMP_name_res PDU” and transmits it to the projector 102b.

In step S2305, the projector 102b extracts the first ID from the “LMP_name_res PDU” received from the electronic blackboard 102a. Further, the projector 102b reads out the second ID created by its own ID change unit 711.

In step S2306, the electronic blackboard 102a transmits “LMP_name_req PDU” to the projector 102b.

In step S2307, when the projector 102b receives the “LMP_name_req PDU”, the projector 102b sets a random number (the second ID) created at regular intervals as an ASCII character string in a name fragment parameter of “LMP_name_res PDU” and transmits it to the electronic blackboard 102a.

In step S2308, the electronic blackboard 102a extracts the second ID from the “LMP_name_res PDU” received from the projector 102b. Further, the electronic blackboard 102a reads out the first ID created by its own ID change unit 711.

In accordance with the above-mentioned process, the electronic blackboard 102a and the projector 102b can obtain the first ID and the second ID.

In the present embodiment, processes other than the above-mentioned ID obtainment processes (the first ID obtainment process and the second ID obtainment process) are the same as the connection process shown in FIGS. 12-14.

### Fourth Embodiment

In the third embodiment, the functions of the ID transmitter 101 in the first embodiment are realized using the electronic device 102. In the same manner, functions of the ID transmitter 101 in the second embodiment may be realized using the electronic device 102.

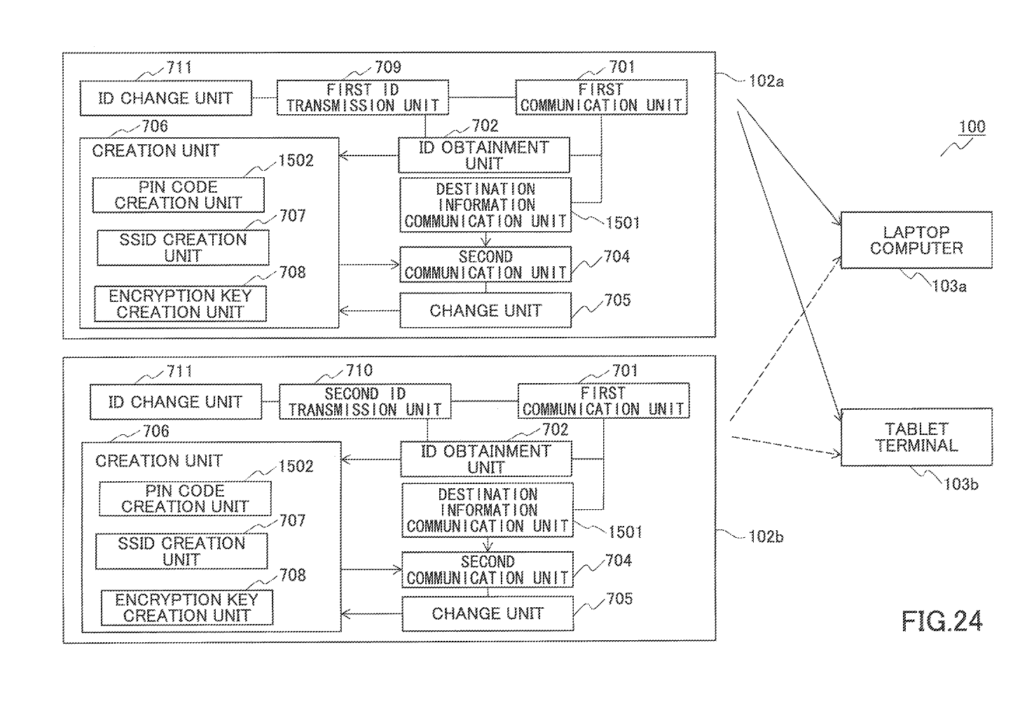

FIG. 24 is a diagram showing a functional configuration of a communication system according to a fourth embodiment. In an example shown in FIG. 24, the electronic blackboard 102a further includes the first ID transmission unit 709 that transmits the first ID and the ID change unit 711 in comparison with the configuration of the second embodiment shown in FIG. 15. Further, the projector 102b further includes the second ID transmission unit 710 that transmits the second ID and the ID change unit 711.

In the following, a difference from the second embodiment is mainly described, as otherwise the configuration is the same as in the second embodiment.

The first ID transmission unit 709 according to the present embodiment uses the first communication unit 701 of the electronic blackboard 102a in order to transmit the first ID in Bluetooth communication, for example. Further, the first ID transmission unit 709 is realized using a software process in accordance with a program executed by the CPU 501 shown in FIG. 5, for example.

The ID change unit 711 of the electronic blackboard 102a has the same functions as in the second embodiment. The ID change unit 711 is realized using a software process in accordance with a program executed by the CPU 501 shown in FIG. 5, for example. Accordingly, for the electronic blackboard 102a according to the present embodiment, it is not necessary to add hardware or the like to the electronic blackboard 102a in the second embodiment.

The second ID transmission unit 710 according to the present embodiment uses the first communication unit 701 of the projector 102b in order to transmit the second ID in Bluetooth communication, for example. Further, the second ID transmission unit 710 is realized using a software process in accordance with a program executed by the CPU of the projector 102b, for example.

The ID change unit 711 of the projector 102b has the same functions as in the second embodiment. The ID change unit 711 is realized using a software process in accordance with a program executed by the CPU of the projector 102b, for example. Accordingly, for the projector 102b according to the present embodiment, it is not necessary to add hardware or the like to the projector 102b in the second embodiment.

### <Flow of Process>

In the present embodiment, an ID obtainment process between communication apparatuses having the functions of the ID transmitter 101 such as the electronic blackboard 102a and the projector 102b is performed in the procedure shown in FIG. 23, for example, in the same manner as in the third embodiment.

In the present embodiment, processes other than the above-mentioned ID obtainment process (the first ID obtainment process and the second ID obtainment process) are the same as the connection process shown in FIGS. 18-20.

### Fifth Embodiment

In the present embodiment, the creation unit 706 in the first to fourth embodiments changes algorithms to create the SSID, the encryption key, and the PIN code in each conference, for example.

A regular conference often has regular participants and the same terminals are often used, for example. Accordingly, in each conference to be held, an algorithm to create the SSID by the SSID creation unit 707, an algorithm to create the encryption key by the encryption key creation unit 708, and/or an algorithm to create the PIN code by the PIN code creation unit 1502 is changed.

For example, it is assumed that a conference (communication) is held using the system configuration of the first to fourth embodiments and calculation in Formulas (1) to (3) used in the first to fourth embodiments is executed by library software, for example. Accordingly, a plurality of sets of library software having different arithmetic expressions in Formulas (1) to (3) are prepared in advance and when the regular conference ends, one of the plurality of sets of library software is distributed to terminals participating in communication of the communication system 100, for example. This distribution is performed from a communication apparatus of a chairperson of the conference, for example.

When the change unit 705 of the communication apparatus according to the present embodiment such as the electronic blackboard 102a receives the distribution of the library software, the change unit 705 updates library software to be used by the creation unit 706.

In accordance with this, when a next conference is held, an SSID, an encryption key, and/or a PIN code are created by the distributed library software.

The above-mentioned process is only an example and does not limit a scope of the present invention.

For example, while the library software (algorithm) used by the creation unit 706 is changed in each conference in the above-mentioned description, the library software may be changed at a predetermined time or date, for example. In this case, when the address list is distributed in steps S1409 to S1411 in the sequence chart shown in FIG. 14, for example, information about a time schedule to change the library software in the future and library software to be used may be reported.

Alternatively, when a conference is held, the electronic blackboard 102a may display information indicative of library software to be used in the conference. The change unit 705 of each communication apparatus changes the library software based on information input by a user, for example. In accordance with this, each communication apparatus can create the SSID, the encryption key, and the PIN code using a common algorithm. Although this method requires an input operation, the method enables only those participants who can visually confirm the display of the electronic blackboard 102a to appropriately set the library software.

### Sixth Embodiment

In the present embodiment, a time to change the second ID to be transmitted by the second ID transmitter 101b is determined in accordance with a time to change the first ID to be transmitted by the first ID transmitter 101a.

### <Functional Configuration>

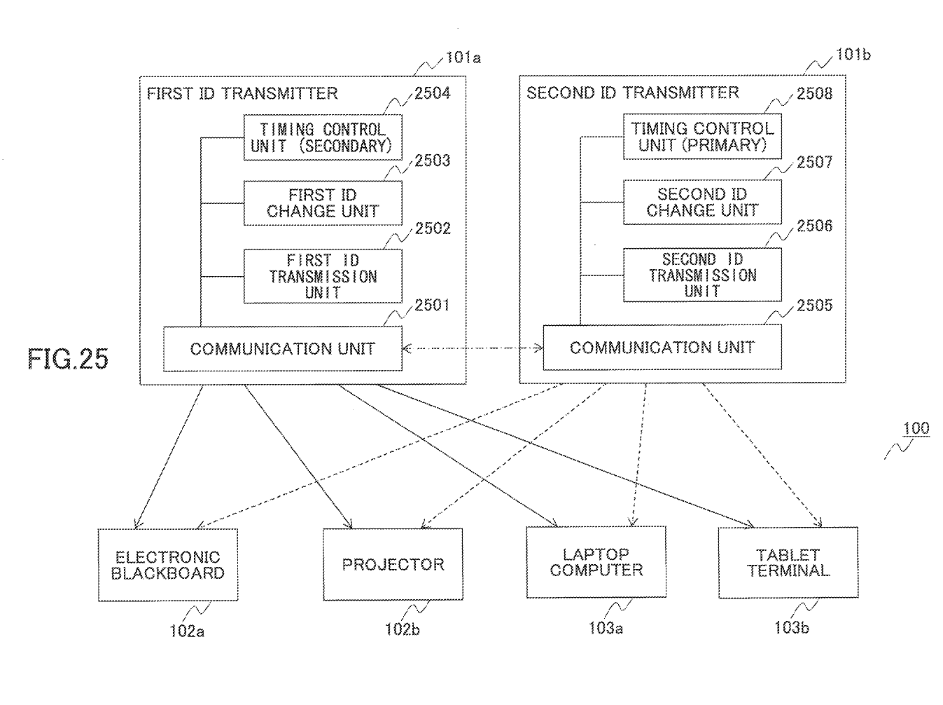

FIG. 25 is a diagram showing a functional configuration of a communication system according to the sixth embodiment. In FIG. 25, it is assumed that functional configurations of the electronic blackboard 102a, the projector 102b, the laptop computer 103a, and the tablet terminal 103b are the same as the functional configuration of the electronic blackboard 102a in the first embodiment shown in FIG. 7, for example. Further, it is assumed that a system configuration of the communication system 100 according to the present embodiment is the same as the system configuration shown in FIG. 1. In the following, a difference from the first embodiment is mainly described.

### (Functional Configuration of ID Transmitter)

In FIG. 25, the first ID transmitter 101a includes a communication unit 2501, a first ID transmission unit 2502, a first ID change unit 2503, and a timing control unit (secondary) 2504.

The communication unit 2501 performs short-range wireless communication such as Bluetooth communication with a plurality of communication apparatuses (the electronic blackboard 102a, the projector 102b, the laptop computer 103a, and the tablet terminal 103b) and the second ID transmitter 101b. The communication unit 2501 includes the short-range wireless communication unit 404 and the antenna 405 shown in FIG. 4, for example. The communication unit 2501 is realized using a software process in accordance with a program executed by the CPU 401, for example.

The first ID transmission unit 2502 uses the communication unit 2501 in order to transmit the first ID. The first ID transmission unit 2502 is realized using a software process in accordance with a program executed by the CPU 401 shown in FIG. 4, for example.

The first ID change unit 2503 changes the first ID transmitted by the first ID transmission unit 2502. The first ID change unit 2503 is realized using a software process in accordance with a program executed by the CPU 401 shown in FIG. 4, for example.

The timing control unit (secondary) 2504 performs control such that a time to change the second ID by the second ID transmitter 101b is determined in accordance with a time to change the first ID by the first ID transmitter 101a. A specific control will be described later. The timing control unit (secondary) 2504 is realized using a software process in accordance with a program executed by the CPU 401 shown in FIG. 4, for example.

The second ID transmitter 101b includes a communication unit 2505, a second ID transmission unit 2506, a second ID change unit 2507, and a timing control unit (primary) 2508.

The communication unit 2505 performs short-range wireless communication such as Bluetooth communication with a plurality of communication apparatuses and the first ID transmitter 101a. The communication unit 2505 includes the short-range wireless communication unit 404 and the antenna 405 shown in FIG. 4, for example. The communication unit 2505 is realized using a software process in accordance with a program executed by the CPU 401.

The second ID transmission unit 2506 uses the communication unit 2505 in order to transmit the second ID. The second ID transmission unit 2506 is realized using a software process in accordance with a program executed by the CPU 401 shown in FIG. 4, for example.

The second ID change unit 2507 changes the second ID transmitted by the second ID transmission unit 2506. The second ID change unit 2507 is realized using a software process in accordance with a program executed by the CPU 401 shown in FIG. 4, for example.

The timing control unit (primary) 2508 performs control such that a time to change the second ID by the second ID transmitter 101b is determined in accordance with a time to change the first ID by the first ID transmitter 101a. A specific control will be described later. The timing control unit (primary) 2508 is realized using a software process in accordance with a program executed by the CPU 401 shown in FIG. 4, for example.

### <Outline of Process>

In accordance with the above-mentioned configuration, in the communication system 100 according to the present embodiment, the first ID transmitter 101a operates as a secondary terminal and the second ID transmitter 101b operates as a primary terminal such that a time to change the ID is determined in accordance with a time to change the ID by the first ID transmitter 101a.

For example, the second ID transmitter 101b operating as the primary terminal actively executes the inquiry procedure of Bluetooth communication to transmit a predetermined ID packet (hereafter “ID packet for synchronization”) to the first ID transmitter 101a operating as the secondary terminal.

The ID packet includes an Inquiry Access Code (IAC). This IAC is created by using a Lower Address Part (LAP) in a lower portion of a Bluetooth device address.

Preferably, the ID packet for synchronization transmitted by the second ID transmitter 101b includes an IAC created using a value (0x9E8B20, for example) different from a value (0x9E8B33) of an LAP used by a General IAC (GIAC) so that only the first ID transmitter 101a can respond. Further, the first ID transmitter 101a operating as the secondary terminal stores in advance an IAC (IAC for synchronization) created using the LAP.

In accordance with this, only the first ID transmitter 101a responds to the ID packet for synchronization transmitted by the second ID transmitter 101b while other apparatuses responsive to an ID packet including the GIAC do not respond.

The second ID transmitter 101b operating as the primary terminal transmits this ID packet for synchronization at predetermined intervals (every minute, for example).

When the first ID transmitter 101a operating as the secondary terminal receives this ID packet for synchronization, the ID transmitter 101a transmits an FHS packet including information about its own Bluetooth device address, a device class of the ID transmitter 101, and the like in response. Since the device class of the ID transmitter 101 has not been standardized as mentioned above, an originally defined code is used.

After the first ID transmitter 101a has created (changed) the first ID, if the first ID transmitter 101a receives the ID packet for synchronization after a predetermined time (one hour, for example) has elapsed, the first ID transmitter 101a changes the first ID (creates a first ID anew) by the first ID change unit 2503. The first ID transmitter 101a transmits an FHS packet including information indicative of the ID change in response to the received ID packet for synchronization to the second ID transmitter 101b that has transmitted the ID packet for synchronization.

The information indicative of the ID change is reported using two bits for reservation in a payload of the FHS packet, for example.

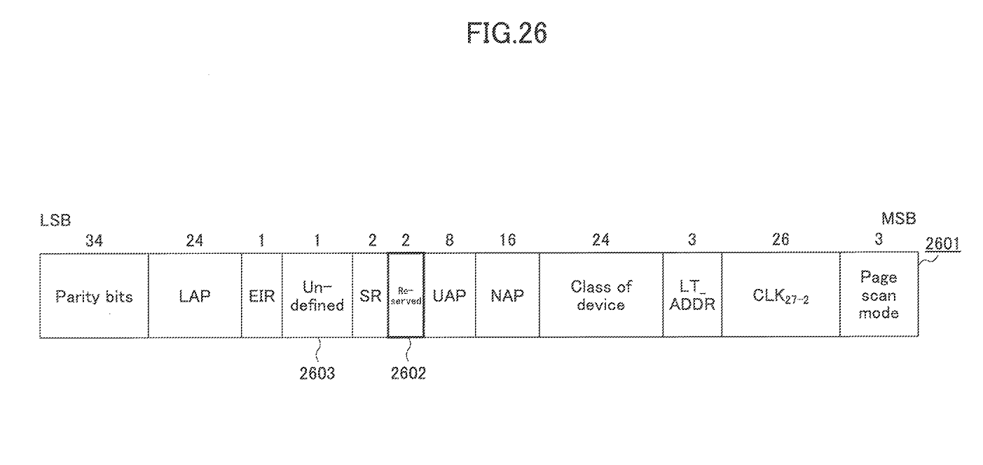

FIG. 26 is a diagram showing an FHS packet according to the present embodiment. In an example shown in FIG. 26, an FHS packet 2601 includes two reserved bits 2602. For example, the first ID transmitter 101a transmits the FHS packet 2601 to the second ID transmitter 101b in which the reserved bits 2602 are set to be “11” if there is an ID change or the reserved bits 2602 are set to be “00” if there is no ID change.

This report of the presence or absence of the ID change using the reserved bits 2602 in the FHS packet 2601 is an example. The first ID transmitter 101a may report the presence or absence of the ID change using un-defined bits 2603 or the like in the FHS packet 2601, for example.

When the second ID transmitter 101b operating as the primary terminal receives the FHS packet including information indicative of the ID change from the first ID transmitter 101a, the second ID transmitter 101b changes the second ID (creates a second ID anew) by the second ID change unit 2507.

After that, if the first ID transmitter 101a and the second ID transmitter 101b receive “LMP_name_req PDU” from a communication apparatus such as the laptop computer 103a, the first ID transmitter 101a and the second ID transmitter 101b transmit “LMP_name_res PDU” including the newly created ID (random number) in response.

In the following, an example of a specific process of the first ID transmitter 101a operating as the secondary terminal and the second ID transmitter 101b operating as the first terminal is described with reference to a flowchart.

### <Flow of Process>

### (Flow of Process of First ID Transmitter)

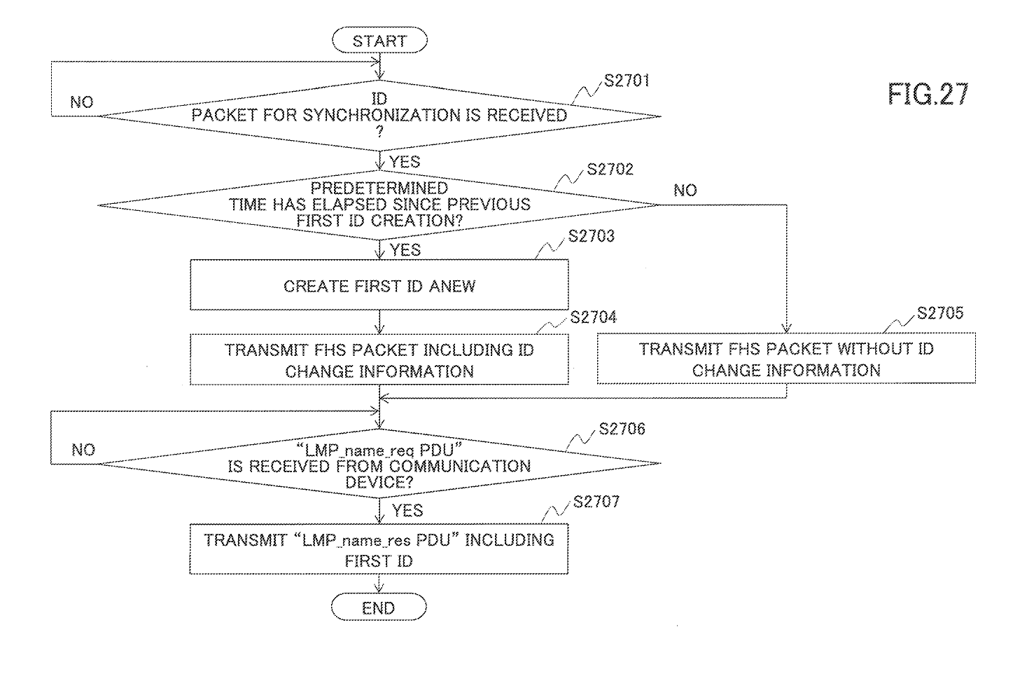

FIG. 27 is a flowchart showing a process of the first ID transmitter 101a according to the sixth embodiment. It is assumed that the first ID transmitter 101a operates as the secondary terminal mentioned above.

In step S2701, if the first ID transmitter 101a receives an ID packet for synchronization, the first ID transmitter 101a performs a process from step S2702.

In step S2702, the timing control unit (secondary) 2504 of the first ID transmitter 101a determines whether a predetermined time (one hour, for example) has elapsed since a previous first ID creation. If the predetermined time has not elapsed (NO), the process proceeds to step S2705 and the timing control unit (secondary) 2504 transmits an FHS packet without ID change information to a source (the second ID transmitter 101b in this case) of the ID packet for synchronization in response. By contrast, if the predetermined time has elapsed (YES), the timing control unit 2504 creates a first ID anew by the first ID change unit 2503 (step S2703) and transmits an FHS packet including ID change information to the second ID transmitter 101b in response (step S2704).

After that, in step S2706, if the first ID transmitter 101a receives “LMP_name_req PDU” from the communication apparatus (YES), the first ID transmitter 101a transmits “LMP_name_res PDU” including the first ID in response (step S2707).

### (Flow of Process of Second ID Transmitter)

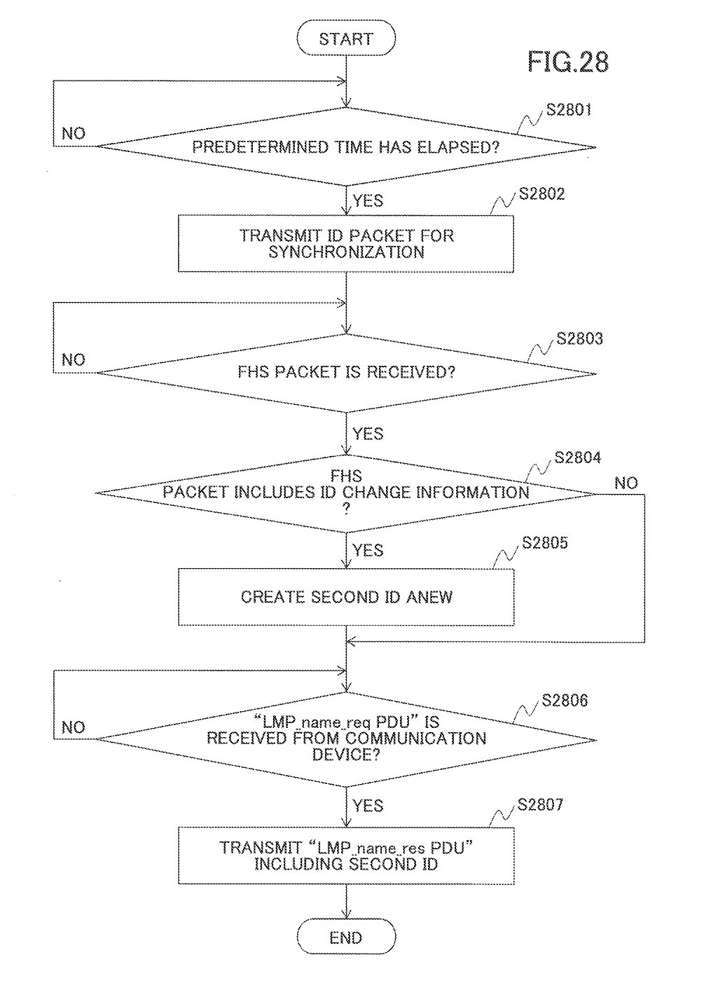

FIG. 28 is a flowchart showing a process of the second ID transmitter 101b according to the sixth embodiment. It is assumed that the second ID transmitter 101b operates as the primary terminal mentioned above.

In step S2801, each time a predetermined time (one minute, for example) has elapsed (YES), the second ID transmitter 101b performs a process from step S2802.

In step S2802, the timing control unit (primary) 2508 of the second ID transmitter 101b uses the communication unit 2505 in order to transmit an ID packet for synchronization to the ID transmitter 101 (the first ID transmitter 101a in this case) operating as the secondary terminal.

In step S2803, the timing control unit (primary) 2508 waits for reception of an FHS packet. If the FHS packet is received (YES), the timing control unit (primary) 2508 performs a process from step S2804.

In step S2804, the timing control unit (primary) 2508 determines whether the received FHS packet includes ID change information. If the received FHS packet includes the ID change information (YES), the second ID change unit 2507 creates a second ID anew (step S2805). By contrast, if the received FHS packet does not include the ID change information (NO), the second ID is not created anew.

After that, in step S2806, if the second ID transmitter 101b receives “LMP_name_req PDU” from the communication apparatus (YES), the second ID transmitter 101b transmits “LMP_name_res PDU” including the second ID in response (step S2807).

As mentioned above, according to the present embodiment, the second ID transmitter 101b operating as the primary terminal can update the second ID in accordance with the first ID transmitter 101a updating the first ID.

### Seventh Embodiment

In the above-mentioned first to sixth embodiments, the first ID transmitter 101a (or the first ID transmission unit 709) that transmits the first ID and the second ID transmitter 101b (or the second ID transmission unit 710) that transmits the second ID are separately disposed. However, the first ID transmitter 101a that transmits the first ID and the second ID transmitter 101b that transmits the second ID may be configured to be the same ID transmitter 101.

### <System Configuration>

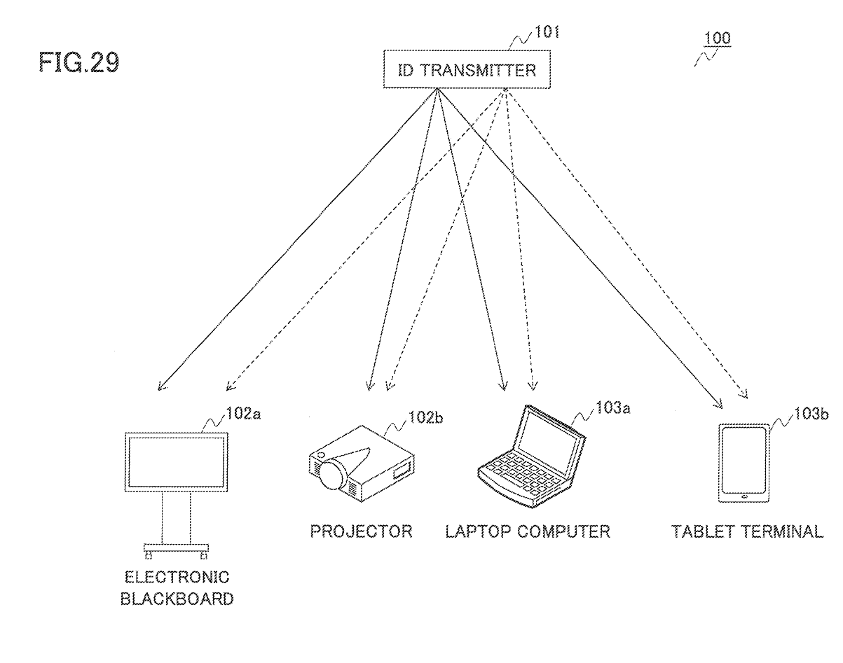

FIG. 29 is a diagram showing a configuration of a communication system according to a seventh embodiment. In FIG. 29, the communication system 100 includes the ID transmitter 101, the electronic blackboard 102a, the projector 102b, the laptop computer 103a, the tablet terminal 103b, and the like. In the following, since configurations other than the configuration of the ID transmitter 101 are the same as in the communication system 100 shown in FIG. 1, a difference from the communication system 100 is mainly described.

The ID transmitter 101 has a function of the first ID transmitter 101a and a function of the second ID transmitter 101b shown in FIG. 1 and transmits the first ID and the second ID by the first wireless communication method such as Bluetooth.

### <Functional Configuration>

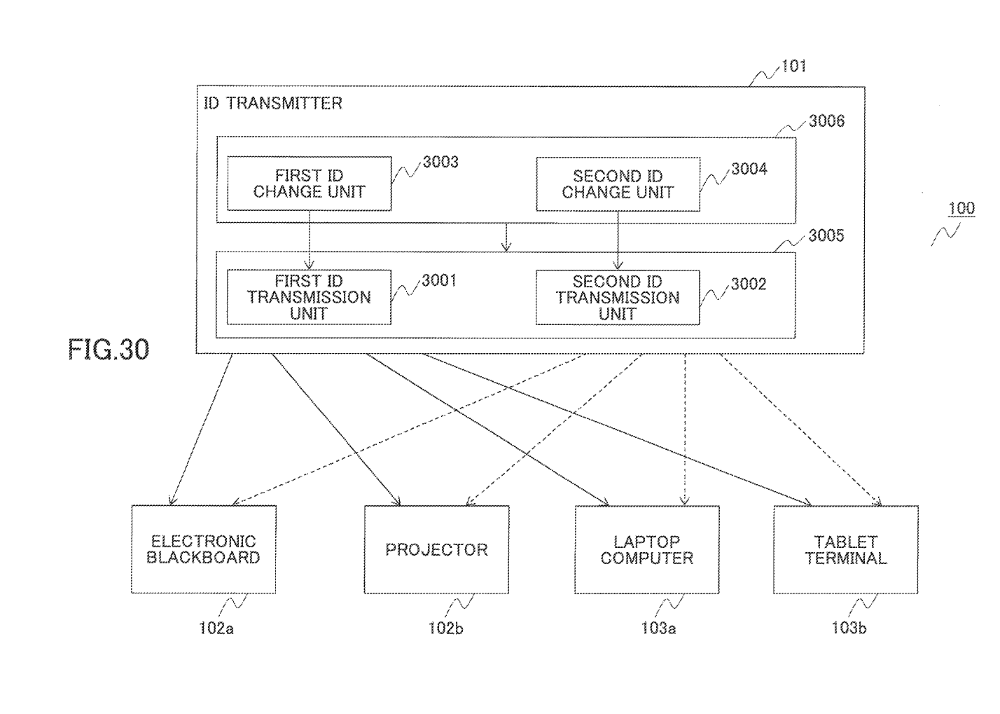

FIG. 30 is a diagram showing a functional configuration of the communication system 100 according to the seventh embodiment.

The ID transmitter 101 includes a first ID transmission unit 3001, a second ID transmission unit 3002, a first ID change unit 3003, and a second ID change unit 3004, for example.

The first ID transmission unit 3001 transmits the first ID. The second ID transmission unit 3002 transmits the second ID. In the present embodiment, the first ID transmission unit 3001 and the second ID transmission unit 3002 may be realized using a single ID transmission unit 3005. For example, the ID transmission unit 3005 may transmit the first ID and the second ID. The first ID transmission unit 3001, the second ID transmission unit 3002, and the ID transmission unit 3005 are realized using the short-range wireless communication unit 404, the antenna 405, and a software process in accordance with a program executed by the CPU 401 shown in FIG. 4, for example.

The first ID change unit 3003 changes the first ID and the second ID change unit 3004 changes the second ID. In the present embodiment, the first ID change unit 3003 and the second ID change unit 3004 may be realized using a single ID change unit 3006. Further, if the single ID transmission unit 3005 transmits the first ID and the second ID, the ID change unit 3006 performs a process of switching between the first ID and the second ID transmitted by the ID transmission unit 3005. The first ID change unit 3003, the second ID change unit 3004, and the ID change unit 3006 are realized using a software process in accordance with a program executed by the CPU 401 shown in FIG. 4, for example.

Functional configurations of the electronic blackboard 102a, the projector 102b, the laptop computer 103a, and the tablet terminal 103b are the same as the functional configuration of the electronic blackboard 102a according to the first embodiment shown in FIG. 7.

### <Flow of Process>

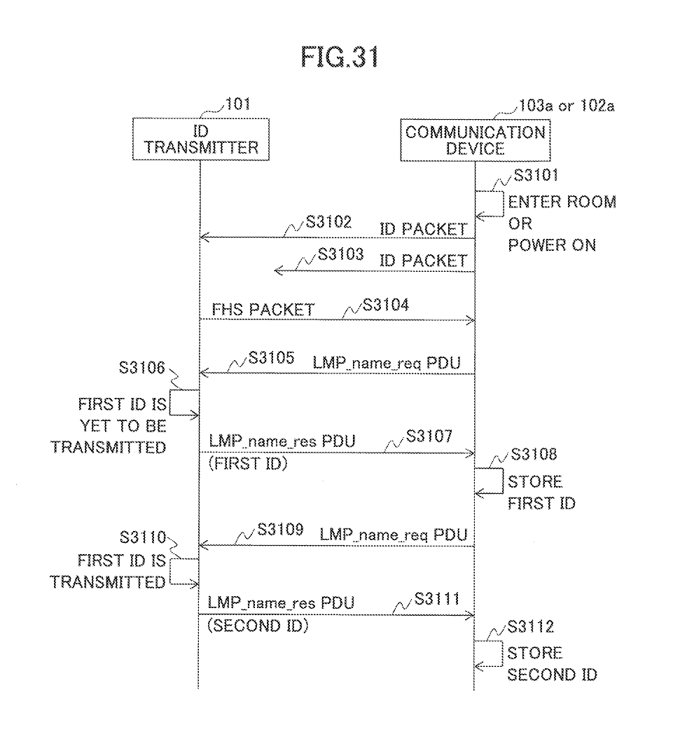

FIG. 31 is a sequence chart showing an ID obtainment process according to the seventh embodiment.

In step S3101, a participant of a conference having the laptop computer 103a (an example of a communication apparatus) which is powered on enters a conference room or the electronic blackboard 102a (another example of the communication apparatus) disposed on the conference room is powered on. In response to this, the communication apparatus starts an inquiry procedure as a primary terminal of Bluetooth. When the communication apparatus starts the inquiry procedure, the communication apparatus repeatedly transmits an ID packet (steps S3102 and S3103).

In step S3104, when the ID transmitter 101 receives the ID packet from the communication apparatus, the ID transmitter 101 transmits an FHS packet including information about its own Bluetooth device address, a device class of the ID transmitter 101, and the like (step S3104). In response to this, the communication apparatus successively establishes a physical link, a connection of baseband layers for transmitting and receiving packets, and a connection between link managers with the ID transmitter 101.

In step S3105, when the connection between the link managers is established with the ID transmitter 101, the communication apparatus transmits “LMP_name_req PDU” to the ID transmitter 101.

In step S3106, the ID transmitter 101 receives the “LMP_name_req PDU” and determines whether the first ID has been transmitted to the communication apparatus which transmitted the “LMP_name_req PDU”. In this case, since the ID transmitter 101 has not transmitted the first ID to the communication apparatus, the ID transmitter 101 sets the first ID as an ASCII character string in a name fragment parameter of “LMP_name_res PDU” and transmits it to the communication apparatus in step S3107.

In step S3108, when the communication apparatus receives the “LMP_name_res PDU” from the ID transmitter 101, the communication apparatus converts the ASCII character string set in the name fragment parameter into a numerical value and stores it as the first ID in the RAM 602 shown in FIG. 6, for example.

In step S3109, the communication apparatus transmits “LMP_name_req PDU” to the ID transmitter 101 again.

In step S3110, the ID transmitter 101 receives the “LMP_name_req PDU” and determines whether the first ID has been transmitted to the communication apparatus which transmitted the “LMP_name_req PDU”. In this case, since the ID transmitter 101 has transmitted the first ID to the communication apparatus, the ID transmitter 101 sets the second ID as an ASCII character string in the name fragment parameter of “LMP_name_res PDU” and transmits it to the communication apparatus in step S3111.

In step S3112, when the communication apparatus receives the “LMP_name_res PDU” from the ID transmitter 101, the communication apparatus converts the ASCII character string set in the name fragment parameter into a numerical value and stores it as the second ID in the RAM 602 shown in FIG. 6, for example.

In accordance with the above-mentioned process, the ID transmitter 101 can successively provide the first ID and the second ID to the communication apparatus. In addition, the process shown in FIG. 31 is an example and the ID transmitter 101 may alternately transmit the first ID and the second ID at predetermined intervals, for example.

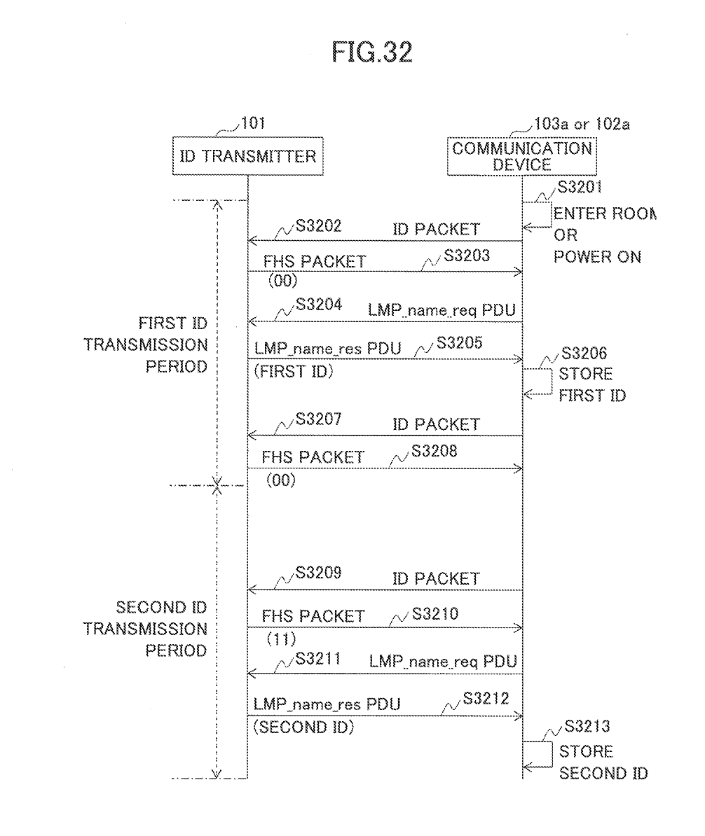

FIG. 32 is a sequence chart showing another ID obtainment process according to the seventh embodiment. In the following description, it is assumed that the ID change unit 3006 shown in FIG. 30 alternately switches an ID to be transmitted by the ID transmission unit 3005 between the first ID and the second ID at predetermined intervals (every five seconds, for example). Further, it is assumed that a period when the ID transmission unit 3005 transmits the first ID is referred to as a first ID transmission period and a period when the ID transmission unit 3005 transmits the second ID is referred to as a second ID transmission period.

In step S3201, a participant of a conference having the laptop computer 103a (an example of a communication apparatus) which is powered on enters a conference room or the electronic blackboard 102a (another example of the communication apparatus) disposed on the conference room is powered on. In response to this, the communication apparatus starts an inquiry procedure as a primary terminal of Bluetooth. When the communication apparatus starts the inquiry procedure, the communication apparatus repeatedly transmits an ID packet (step S3202).

In step S3203, the ID transmitter 101 receives the ID packet from the communication apparatus and transmits an FHS packet including information indicative of the first ID transmission period or the second ID transmission period. The information indicative of the period is reported using the two reserved bits 2602 in the FHS packet 2601 shown in FIG. 26. It is assumed that if the reserved bits 2602 are set to be “00”, the first ID transmission period is indicted and if the reserved bits 2602 are set to be “11”, the second ID transmission period is indicated. In accordance with this, the communication apparatus that receives the FHS packet from the ID transmitter 101 can obtain information about the first ID transmission period or the second ID transmission period by checking the reserved bits 2602 in the FHS packet.

In FIG. 32, during the first ID transmission period, the ID transmitter 101 sets the reserved bits 2602 of the FHS packet to be “00” and transmits the FHS packet to the communication apparatus. When the communication apparatus receives the FHS packet, the communication apparatus performs Bluetooth communication and establishes a connection between link managers.

In step S3204, since the communication apparatus has not received the first ID in the first ID transmission period, the communication apparatus transmits “LMP_name_req PDU” to the ID transmitter 101 in order to obtain the first ID.

In step S3205, when the ID transmitter 101 receives the “LMP_name_req PDU” from the communication apparatus, the ID transmitter 101 transmits “LMP_name_res PDU” including the first ID in the first ID transmission period or transmits “LMP_name_res PDU” including the second ID in the second ID transmission period. In FIG. 32, during the first ID transmission period, the ID transmitter 101 transmits the “LMP_name_res PDU” including the first ID.

In step S3206, the communication apparatus receives the “LMP_name_res PDU” from the ID transmitter 101 and stores the first ID included in the “LMP_name_res PDU” in the RAM 602 shown in FIG. 6, for example.

After that, the communication apparatus that has not received the second ID transmits the ID packet at predetermined intervals (every three seconds, for example) (steps S3207 and S3209). The communication apparatus checks information indicative of the first ID transmission period or the second ID transmission period in the FHS packet transmitted from the ID transmitter 101 in response.

If the FHS packet received from the ID transmitter 101 includes “00” indicative of the first ID transmission period (step S3208), the communication apparatus is in a stand-by state. By contrast, if the FHS packet received from the ID transmitter 101 includes “11” indicative of the second ID transmission period (step S3210), the communication apparatus transmits “LMP_name_req PDU” to the ID transmitter 101 in order to obtain the second ID (step S3211).

In step S3212, when the ID transmitter 101 receives the “LMP_name_req PDU” from the communication apparatus, the ID transmitter 101 transmits “LMP_name_res PDU” including the first ID in the first ID transmission period or transmits “LMP_name_res PDU” including the second ID in the second ID transmission period. In FIG. 32, during the second ID transmission period, the ID transmitter 101 transmits the “LMP_name_res PDU” including the second ID.

In step S3213, the communication apparatus receives the “LMP_name_res PDU” from the ID transmitter 101 and stores the second ID included in the “LMP_name_res PDU” in the RAM 602 shown in FIG. 6, for example.

In accordance with the above-mentioned process, the communication apparatus can obtain the first ID and the second ID from the ID transmitter 101 that alternately transmits the first ID and the second ID at predetermined intervals.

### <Conclusion>

The system (100) according to each of the above-mentioned embodiments includes:

a plurality of communication apparatuses (102a, 102b, 103a, and 103b) that perform communication using predetermined information, wherein each of the plurality of communication apparatuses includes a detection unit (702) that detects a first signal issued from a first signaling part and a second signal issued from a second signaling part and a communication unit (704 or 701) that performs the communication with another communication apparatus (102) within an area where the detection unit (702) can detect the first signal and the second signal.

In accordance with the above-mentioned configuration, the system (100) can facilitate setting of network connection while ensuring security of the network connection.

Preferably, the system (100) may include a single signaling device (101) that issues the first signal and the second signal. In accordance with this, by disposing the single signaling device (101) in the system (100), the system (100) can facilitate setting of network connection while ensuring security of the network connection.

Alternatively, the system (100) may include a first signaling device (101a) that issues the first signal and a second signaling device (101b) that issues the second signal. In accordance with this, the system (100) can also facilitate controlling a communication area in addition to facilitating setting of network connection while ensuring security of the network connection.

Further, one of the plurality of communication apparatuses (102a, 102b, 103a, and 103b) may include a first signaling unit (709) that issues the first signal or a second signaling unit (710) that issues the second signal. By transmitting the first signal or the second signal using a single communication apparatus in this manner, it is possible to reduce hardware members of the signaling device or installation costs and it is possible to easily set a communication area in any location.

In addition, reference numerals in parentheses and names are only an example and are added in order to make understanding easier. This is not intended to limit the scope of the present invention.

### [Additional Description to Embodiments]

Each of the above-mentioned embodiments is an example of the communication system 100 according to the present invention and does not limit the scope of the present invention. For example, while the electronic blackboard 102a and the projector 102b are described as the electronic device 102, the electronic device 102 may include an image forming device having a communication function such as a multifunction peripheral, a printer, a scanner, or a digital camera, or a video conference device, for example.

The communication system 100 may be configured with a plurality of information terminals 103 without including the electronic device 102. In the same manner, the communication system 100 may be configured with a plurality of electronic devices 102 without including the information terminal 103.

While the first ID and the second ID are transmitted using Bluetooth communication in the above-mentioned descriptions, the first ID and the second ID may be transmitted by another wireless communication method. In the same manner, while encrypted data communication is performed using a wireless LAN in the above-mentioned descriptions, data communication may be performed by another wireless communication method.

Further, the present invention is not limited to these embodiments, and various variations and modifications may be made without departing from the scope of the present invention.

The present application is based on and claims the benefit of priorities of Japanese Priority Patent Application No. 2014-103435 filed on May 19, 2014 and Japanese Priority Patent Application No. 2015-049287 filed on Mar. 12, 2015, the entire contents of which are hereby incorporated by reference.

What is claimed is:

1. A system comprising a plurality of communication apparatuses, the plurality of communication apparatuses performing communication using predetermined information, each of the plurality of communication apparatuses comprising:
a detection unit configured to detect a first signal issued from a first signaling part and a second signal issued from a second signaling part; and
a communication unit configured to perform the communication with another communication apparatus of the plurality of communication apparatuses within an area where the detection unit can detect the first signal and the second signal.

2. The system as claimed in claim 1, wherein each of the plurality of communication apparatuses comprises a first creation unit configured to create the predetermined information based on the first signal and the second signal that are detected.

3. The system as claimed in claim 1, further comprising a single signaling device configured to issue the first signal and the second signal.

4. The system as claimed in claim 1, further comprising:
a first signaling device configured to issue the first signal; and
a second signaling device configured to issue the second signal.

5. The system as claimed in claim 1, wherein one of the plurality of communication apparatuses comprises a first signaling unit configured to issue the first signal or a second signaling unit configured to issue the second signal.

6. The system as claimed in claim 1, further comprising a signal change unit configured to change the first signal or the second signal.

7. The system as claimed in claim 6, wherein the signal change unit changes the first signal or the second signal depending on time.

8. The system as claimed in claim 6, wherein the signal change unit changes the first signal or the second signal in response to an operation of the communication apparatus.

9. The system as claimed in claim 1, wherein each of the plurality of communication apparatuses comprises a second creation unit configured to create a network identifier in the communication based on the first signal and the second signal that are detected.

10. The system as claimed in claim 9, wherein each of the plurality of communication apparatuses comprises a third creation unit configured to create information based on the first signal and the second signal that are detected, the created information being used to encrypt the communication.

11. The system as claimed in claim 1, wherein the predetermined information includes authentication information used to connect with the communication.

12. The system as claimed in claim 1, further comprising an algorithm change unit configured to change an algorithm to create the predetermined information.

13. The system as claimed in claim 3, wherein the single signaling device successively transmits the first signal and the second signal in response to a request from the communication apparatus.

14. The system as claimed in claim 4, wherein the first signaling device comprises:
a first signal change unit configured to change the first signal; and
a timing control unit configured to report, to the second signaling device, signal change information indicating that the first signal is changed, and
wherein the second signaling device comprises:
a second signal change unit configured to change the second signal in accordance with the reported signal change information.

15. A communication apparatus for performing communication with another communication apparatus using predetermined information shared with the another communication apparatus, the communication apparatus comprising:
a detection unit configured to detect a first signal issued from a first signaling part and a second signal issued from a second signaling part; and
a communication unit configured to perform the communication with the another communication apparatus within an area where the detection unit can detect the first signal and the second signal.

16. A communication method of performing communication among a plurality of communication apparatuses using predetermined information, the communication method comprising:
by each of the plurality of communication apparatuses, detecting a first signal issued from a first signaling part;
by each of the plurality of communication apparatuses, detecting a second signal issued from a second signaling part; and
by each of the plurality of communication apparatuses, creating the predetermined information based on the first signal and the second signal that are detected.
